(19) United States
(12) Patent Application Publication
(10) Pub. No.: US 2026/0280132 A1
(43) Pub. Date: Sep. 17, 2026

(54) eXpeditionary Multi-Band (XMB) Vertical Diamond Antenna System and Method

(71) Applicant: SABRE SYSTEMS, INC., Warminster, PA (US)

(72) Inventors: James K. Breakall, Port Matilda, PA (US); Karl Hosterman, Julian, PA (US); Jack Burbank, Hanover, PA (US); Kade Poorman, Milroy, PA (US)

(73) Assignee: SABRE SYSTEMS, INC., Warminster, PA (US)

(21) Appl. No.: 19/555,299

(22) Filed: Mar. 3, 2026

Related U.S. Application Data
(60) Provisional application No. 63/766,170, filed on Mar. 3, 2025.
(60) Provisional application No. 63/894,230, filed on Oct. 6, 2025.

(51) Int. Cl. H01Q 9/28; H01Q 1/08

(52) U.S. Cl. CPC H01Q 9/285; H01Q 1/087

(57) ABSTRACT

A transportable rapidly deployable High-Frequency (HF) or Multi-Band Vertical Diamond antenna system 100 is configured with a dual orthogonal plane antenna assembly 300 to be easily and quickly deployed and erected virtually anywhere to project and receive HF or Multi-band signals in a uniform radiation pattern having a useful main beam shape and providing a useful gain over a selected frequency band. The eXpeditionary Vertical Diamond antenna system 100 provides wideband, global communications (transmit and receive) in multiple frequency bands in a highly portable, easily setup form factor with first and second orthogonal planar diamond shaped antenna segments which provide consistent gain and Voltage Standing Wave Ratio (VSWR) across the entire HF frequency band and beyond without significant variations in performance over azimuth.

### CROSS-REFERENCE TO RELATED APPLICATIONS AND PRIORITY CLAIMS

This US Utility patent application claims priority to (a) related, commonly owned U.S. provisional patent application no. 63/766170, entitled Transportable Rapidly Deployable High-Frequency (HF) Vertical Diamond Antenna System and Method (filed 3 Mar., 2025) and (b) related, commonly owned U.S. provisional patent application no. 63/894,230, entitled Transportable Rapidly Deployable Expeditionary MultiBand (XMB) Antenna System and Method (filed 6 Oct. 2025), the entire disclosures of which are incorporated herein by reference. This application is also broadly related to applicant's commonly owned U.S. provisional patent application no. 63/766036, entitled Transportable Rapidly Deployable High-Frequency (HF) Horizontal Fan Antenna System and Method, filed 3 Mar. 2025, the entire disclosure of which is also incorporated herein by reference for background, enablement and nomenclature purposes.

### BACKGROUND

### 1. Field

One or more embodiments of the present invention relate to High Frequency (“HF”) band and multi-band antenna and coupling systems for use in transportable wireless communication systems. products, other articles and combinations, and methods and processes for configuring, transporting, erecting and employing High Frequency (“HF”) and multi-band antenna and coupling systems.

### 2. Discussion of the Related Art

Wireless (e.g., Radio) communication systems are traditionally configured to serve a variety of communication needs and are often licensed to transmit and receive in selected radio frequency (“RF”) bands. Transmitters, antennae and receivers are designed and set up to communicate in specific licensed frequency bands for specific communication applications. For example, High Frequency (“HF”) systems operate across the 3-30 MHz frequency band, while Very High Frequency (“VHF”) systems operate across the 30-300 MHz (HF) frequency band and Ultra High Frequency (“UHF”) systems operate across the 300-3000 MHz frequency band. HF systems (i.e., 3 MHz-30 GHz) are usually used and licensed for shortwave broadcasting and amateur radio. VHF systems (i.e., 30 MHz-300MHz) are usually used and licensed for FM radio, television broadcasts, and land mobile wireless communications. And UHF systems (i.e., 300 MHz-3 GHz) are usually used and licensed for mobile phones, Global Positioning Systems, and Wi-Fi networking. For any of these systems, users pair band-dedicated antennae with their application-specific band dedicated radios (because someone setting up Wi-Fi in their apartment doesn't need or want a huge Channel-Master™ style TV antenna brought inside.

High Frequency (“HF”) systems operate across the 3-30 MHz (HF) frequency band in a variety of civilian and military applications using specially configured HF antennas which include application specific compromises that balance practical operating considerations such as available space, required distance between transmitters and receivers, transmitter power, as well as antenna gain, radiation patterns, and impedance or Voltage Standing Wave Ratio (“VSWR”). HF antennas are used in Amateur (or “Ham”) Radio and Shortwave communications over substantial distances, globally. HF transceivers can be used for long-distance communication due to the ionospheric propagation properties of shortwave frequencies.

HF (shortwave) radio waves can bounce off the ionosphere, the part of Earth's atmosphere that's ionized by solar and cosmic radiation. The ionosphere has multiple layers and can reflect radio waves back to the Earth, allowing them to travel beyond the horizon (or beyond Line of Sight (“LOS”)). Several factors play into how far a shortwave radio can transmit signals, including Frequency (different frequencies have different propagation characteristics), Time of Day, Weather Conditions, and Antenna Quality: A well-constructed antenna can significantly enhance transmission and reception capabilities. The antenna's size, type, and orientation directly impact the reach of a signal.

Traditional HF antennas for long distance applications are very large, requiring a significant amount of real estate and infrastructure to establish. Furthermore, traditional HF antennas are complex to set up or erect, requiring a large team of relatively skilled operators with a significant amount of time. Horizontal HF antennas often are hundreds of feet in length, while vertical HF antennas can be hundreds of feet tall and require a commercial grade tower to host. HF antennas often have localized transmission performance notches over certain frequency bands at specified elevation takeoff angles, where performance for a portion of the HF band is significantly less than other portions of the band (in terms of reduced gain and/or increased VSWR). Many HF antennas perform poorly for transmitting unless an external adjustable RF interface network or “tuner” is inserted in the signal path between the radio (e.g., transceiver) and the antenna to allow an operator to optimize or match the antenna's impedance to the radio for a particular use case. Many existing HF antennas are extremely narrowband in nature, restricting the simultaneous use to a very small portion of the HF frequency band, often as small as 2 kHz, which can limit the utility of HF radios for certain modern advanced/complex waveforms.

One example of a prior art vertical HF/broadband antenna system is illustrated in FIG. 1A, a diagram illustrating a HF vertical dipole antenna 2 and method for erecting the antenna including a 12 meter (40 ft.) tall multi-section telescoping fiberglass pole around which is wrapped a spiral of radiator wire connected to open wire feedline at an insulator block 20 feet above ground. The antenna assembly requires users to erect the pole and then attach at least three guy ropes which are staked into the ground with tent pegs. The radiator wires are terminated and must be spiral wrapped around the pole and carefully attached near the top and bottom of the pole at the insulator block which is about 20 ft above the ground to provide a useful connection between an open wire feed line and the radiator wires. The open wire feed line (for connection to a radio) must have a length selected for proper operation with a good antenna matchbox or coupling instrument or tuner. Setting this prior art antenna up properly is not quick, easy or necessarily safe (depending on voltages applied to the antenna terminals). Even when properly set up, the prior art antenna system 2 of FIG. 1A typically exhibits performance gaps in certain portions of the HF frequency band, performing well in some parts of the HF band and poorly in other parts of the band, while requiring a “Good antenna matchbox” in addition to or as part of the attached radio or transceiver (not shown).

Another prior art vertical “G8JNJ” HF/broadband antenna system is illustrated in FIG. 1BA, a diagram illustrating another HF vertical dipole antenna and method for erecting the antenna including a 10 meter (32.8 ft.) tall multi-section pole which is fiberglass for the top 4 meters and conductive for the bottom 6 meters, with a spiral of radiator wire wrapped around the top fiberglass top section. The “G8JNJ” antenna assembly of FIG. 1B requires users to erect the pole sections and then attach at least three guy ropes which are staked into the ground with tent pegs. The radiator wires are terminated and must be spiral wrapped around the pole and carefully attached near the middle and top of the pole while an insulator must be placed under the conductive bottom pole segment. Setting this “G8JNJ” prior art antenna up properly also is not quick, easy or necessarily safe (depending on voltages applied to the antenna terminals). And, as with the prior art antenna of FIG. 1A, this “G8JNJ” typically exhibits performance gaps in certain portions of the HF frequency band, performing well in some parts of the HF band and poorly in other parts of the band, and requires an external tuner (not shown) in addition to or as part of the attached radio or transceiver (e.g., 30).

Users of newer wideband HF radios aim to utilize much higher instantaneous bandwidth to provide larger data rates for modern applications with complex waveforms and “wideband” operation requirements. But traditional HF antenna systems are not well suited for use with such newer radios and so require adjustment with external tuner instruments to properly interface to the radio system, and those adjustments can waste time and create communication delays. These added external tuners add cost, complexity and failure mechanisms to the other issues often facing communication system operators.

Those requiring global communications capability across the entire HF band with instantly available near-full HF bandwidth are facing poor reliability, especially at significant transmit powers (e.g., over one kilowatt), where surprising shortfalls in performance may be encountered in some portions of the frequency band or at some antenna takeoff angles. And those problems are compounded if the user requires communications in other bands (outside the HF band).

There is a need, therefore, for a transportable antenna system and method which overcomes those shortcomings.

### SUMMARY

This Summary of the present disclosure is provided to introduce a selection of representative concepts in a simplified form, which representative concepts are further described below in the Detailed Description of Exemplary Embodiments. This Summary section is not intended to identify key features or essential features of the claim-like statements listed below as numbered clauses or of the appended claims, nor is it intended to be used to limit the scope of those claim-like statements or appended claims.

An aspect of the present disclosure provides a transportable, rapidly deployable, High-Frequency (HF) and multi-band antenna system in a kit form and a method which overcomes the above identified shortcomings.

In a first exemplary embodiment, the HF antenna and coupling system and method of the present invention overcomes the shortcomings of the prior art and provide surprising Expeditionary, HF (“X_{HF}”) performance and transportable (e.g., military) HF wireless global communications capability across the entire HF band with instantly available near-full HF bandwidth, and with much improved reliability, especially at significant transmit powers (e.g., over one kilowatt). This system also supports expeditionary users over a much wider frequency usable bandwidth (including HF, VHF and part of the UHF bands) over nearly all practicable antenna takeoff angles. For multiband use, there is an eXpeditionary multi band (“X_{MB}”) embodiment.

The X_{MB} antenna system is significantly smaller than competitor HF antennas. The system provides surprisingly consistent gain and VSWR performance across a Multi-band range of the 3-500 MHz and does not require any external tuner. The X_{MB} system is far simpler than other HF antennas and can be erected on a site in a much shorter time. The X_{MB} system is much lower cost than comparable HF antennas (comparable in terms of capability). The X_{MB} system is the only known HF/VHF/UHF expeditionary antenna system that provides such a wide operating bandwidth in a small, simple form factor that can be assembled and erected on a selected site by one or two people in a half hour.

The X_{MB} antenna system of the present invention is similar to the eXpeditionary HF (X_{HF}) Vertical Diamond antenna system described in applicants'commonly owned U.S. provisional patent application no. 63/766170 entitled “Transportable Rapidly Deployable High-Frequency (HF) Vertical Diamond Antenna System and Method”, filed 3 Mar. 2025, the entire disclosure of which is incorporated herein by reference. After applicants'initial prototype of the X_{HF} was configured, confidential internal testing in a remote, mountainous location was undertaken, and in that internal prototype testing, applicants discovered an unknown and surprising capability of their X_{HF} antenna system to support communication with distant installations at higher than HF frequency bands. Specifically what applicants'are now referring to as the X_{MB} system demonstrated surprising performance when transmitting in the Very High Frequency (VHF) and Ultra High Frequency (UHF) frequency band and beyond, up to a practical operating upper frequency of 500 MHz. More specifically, it was determined (in confidential prototype testing) that what is now referred to as the X_{MB} antenna of the present invention supports both transmit and receive operations across the entire 30-500 MHz VHF and lower UHF bands.

The X_{MB} antenna system and method for configuring an antenna and transmitting RF signals in HF, VHF and UHF frequency bands has been validated through both modeling and empirical measurement. Applicants'X_{MB} antenna system and method was set up and tested with multiple commercially available radios (e.g., Kenwood™ TM-281, Kenwood™ TM-481, ICOM™ 7610) in the VHF band (55.525 MHz, ~146.520 MHz) and UHF band (444.700 MHz). All of the test radios were capable of outputting at power levels of approximately 50 Watts. Drive testing was conducted for both applicants'X_{MB} antenna and a traditional benchmark band dedicated tailored VHF/UHF antenna (no HF support) for comparison. For VHF communications at 52 MHz, applicants maintained communications to a range of approximately 8 miles in extremely mountainous and forested terrain. At 146 MHz, communications were maintained up to 10 miles in the same mountainous and forested terrain. At 444 MHz a communications range of approximately 6 miles was achieved. For the benchmark dedicated VHF/UHF antenna (no HF support) achievable distances were only 10% farther than the applicants'X_{MB} antenna system (which also provides excellent HF performance). These unexpected results represent a significant and surprising advantage for the radio community as, with the X_{MB} antenna system and method of the present invention, HF, VHF and portions of UHF this large amount of spectrum can be accessed using applicants'single antenna versus requiring use of multiple band-dedicated antenna systems.

The X_{MB} antenna system's performance came about as a surprising improvement over applicants'original X_{HF} antenna work, due to a component redesign. The commercial balun applicants were using (i.e., a commercial 4:1 balun from Palomar Engineers®) was discontinued, and rather than perpetually chasing new vendors, applicants decided to build their own 4:1 Balun using the same enclosure, but with new hand-wound windings made and assembled in-house. By using applicants'new balun as part of a balun assembly mountable on the antenna mast in prototype testing, it was discovered that applicants'antenna system attained surprisingly good and uniform multi-band performance (in VHF and UHF). After this surprising discovery, applicants went back and performed testing on one of applicants'original XHF antennas, and while it works in these bands, it does not perform in VHF and UHF nearly as well as the new X_{MB} antenna system when equipped with applicants'new balun.

Applicants subsequent study of this surprising multi-band performance revealed that in the X_{MB} antenna system of the present invention, the new balun assembly works with the Diamond shape of the antenna elements at the element's bend points (i.e., the middle bend of the diamond and the bend bottom where it sharply bends as it's fitted into the slots that hold it in place and curls back to the connection points), is where the geometry is created to allow surprisingly effective antenna performance in these higher than HF bands. The new balun design accentuates this characteristic. The new Balun is still a 4:1 Balun, but the windings into and through the ferrites are different than in the commercial product.

The above and still further objects, features and advantages of aspects of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE SEVERAL VIEWS OF THE DRAWINGS

The drawings referenced herein form a part of the specification and are incorporated herein by reference. At least some of those drawings are schematic in nature. Features shown in the drawings are meant as illustrative of one or more embodiments by way of example only, and not necessarily illustrative of all embodiments, unless otherwise explicitly indicated.

FIGS. 1A and 1B are drawings and diagrams illustrating prior art vertical HF and multiband antenna systems and methods, and provide useful nomenclature for background purposes.

FIGS. 2A and 2B is a photograph from a user manual or online instructions illustrating the characteristics and features of an embodiment of applicants'transportable rapidly deployable Expeditionary High-Frequency (X_{HF}) vertical diamond antenna system 100 and HF communication method, in accordance with one example of the present invention.

FIGS. 3A and 3B are a diagram and a photograph from a user manual or online instructions illustrating the characteristics and features of an embodiment of applicants'transportable rapidly deployable Expeditionary High-Frequency (X_{HF}) vertical diamond antenna system's base assembly, in accordance with one example of the present invention.

FIGS. 4-32 are photographs of pages or screenshots from a user manual or online instructions illustrating the characteristics and features of an embodiment of applicants'transportable rapidly deployable vertical diamond antenna system 100 and communication method, in accordance with one example of the present invention.

FIGS. 33A-33E illustrate the characteristics and features of an embodiment of applicants'hand-wound balun and method, in accordance with one example of the present invention.

FIG. 34 is a line drawing illustrating the characteristics and features applicants'transportable rapidly deployable Expeditionary High-Frequency (X_{HF}) vertical diamond antenna system assembly elements, in accordance with one example of the present invention.

FIGS. 35-39 are graphical representations of plotted data illustrating VSWR and Gain antenna performance metrics illustrating the characteristics and features of an embodiment of applicants'transportable rapidly deployable Expeditionary High-Frequency (X_{HF}) vertical diamond antenna system over the HF band, in accordance with one example of the present invention.

FIGS. 40-46 are graphical representations of plotted data illustrating VSWR and Gain antenna performance metrics illustrating the characteristics and features of an embodiment of applicants'transportable rapidly deployable eXpeditionary Multi-band (X_{MB}) vertical diamond antenna system in a surprisingly effective multi-band RF transmission method which provides substantial improvements in expeditionary wireless communication applications, in accordance with the present invention.

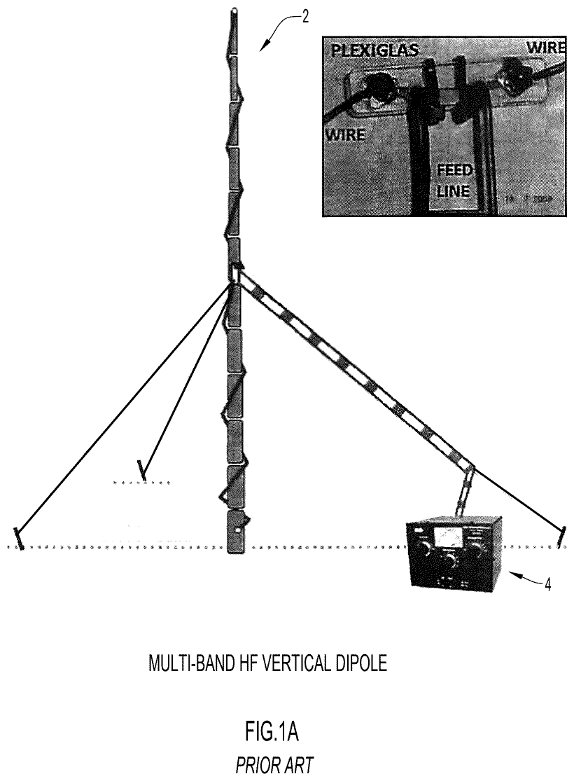

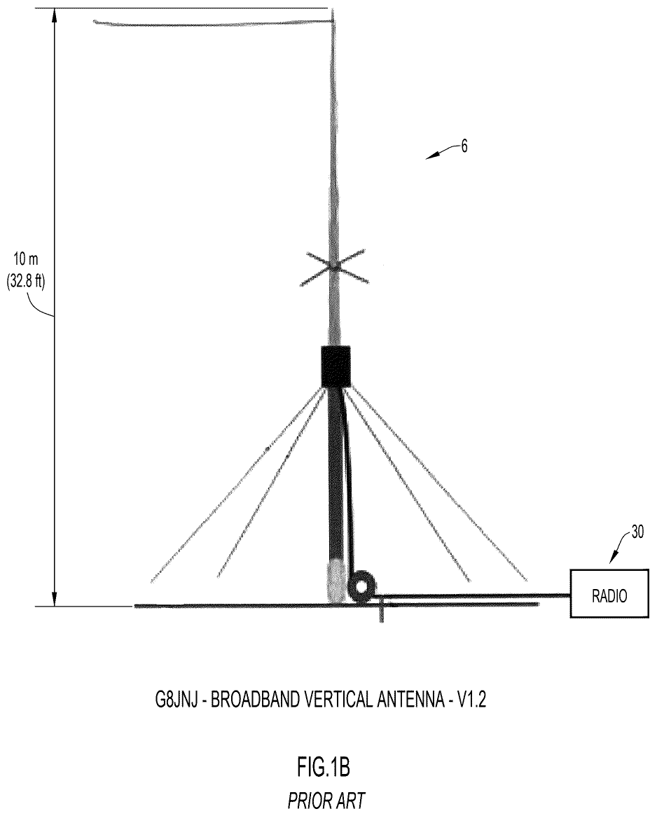

### DETAILED DESCRIPTION OF THE EXEMPLARY EMBODIMENTS

It will be readily understood that the components and features of the exemplary embodiments, as generally described herein and illustrated in the Figures, may be arranged and designed in a wide variety of different configurations. Thus, the following detailed description of the embodiments of the methods, devices, assemblies, apparatus, systems, products, modules, submodules, etc. of the exemplary embodiments, as presented in the Figures, is not intended to limit the scope of the embodiments, as recited in the accompanying claims, but is merely representative of selected embodiments.

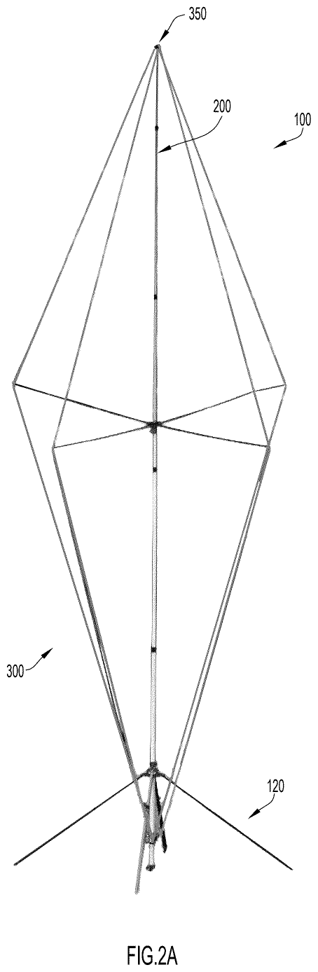

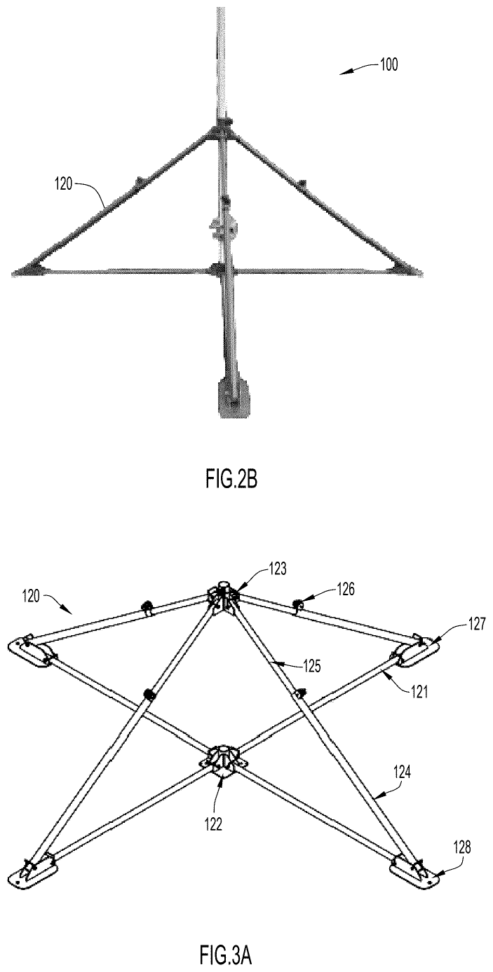

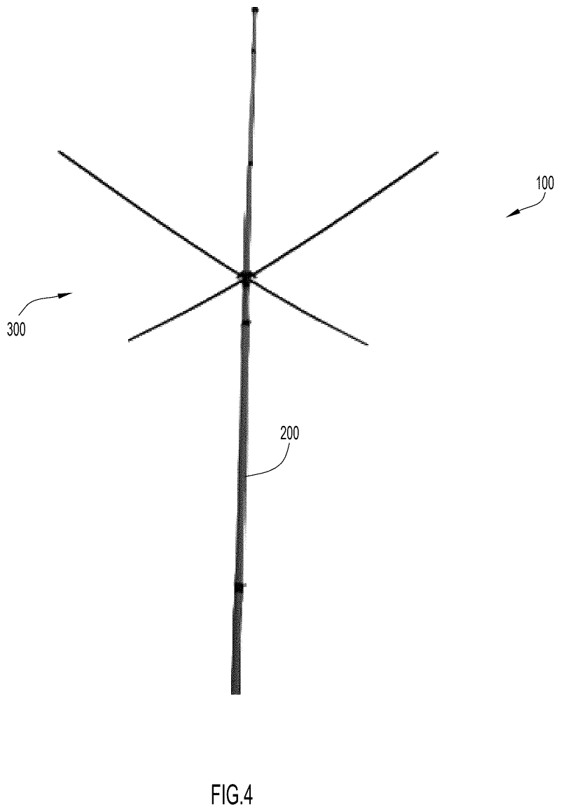

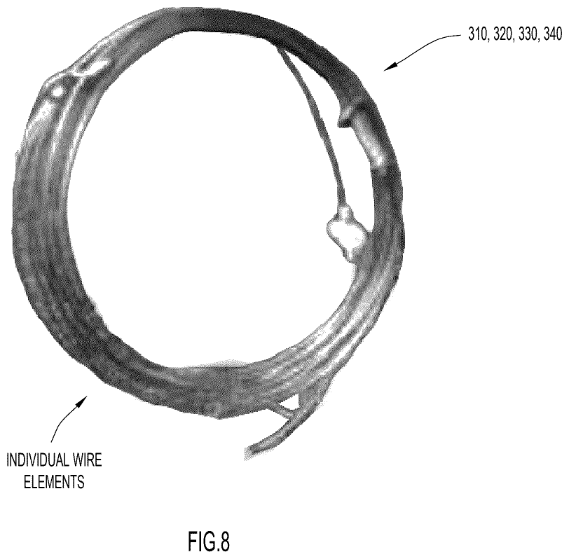

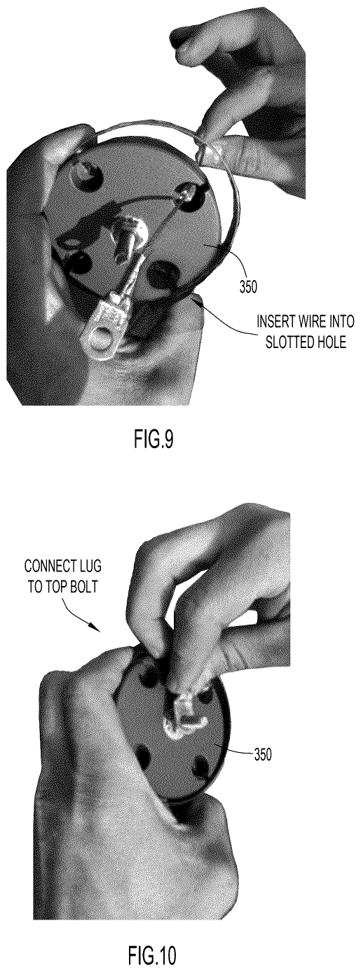

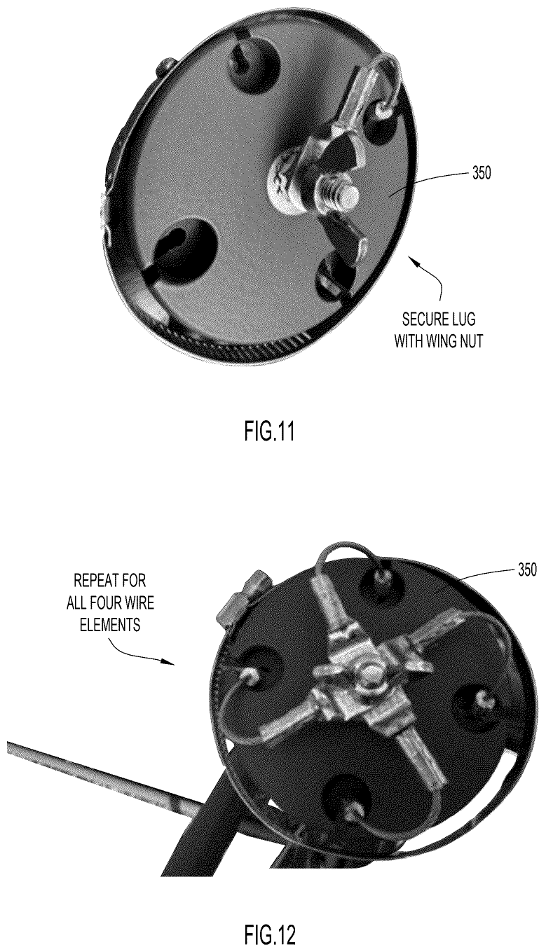

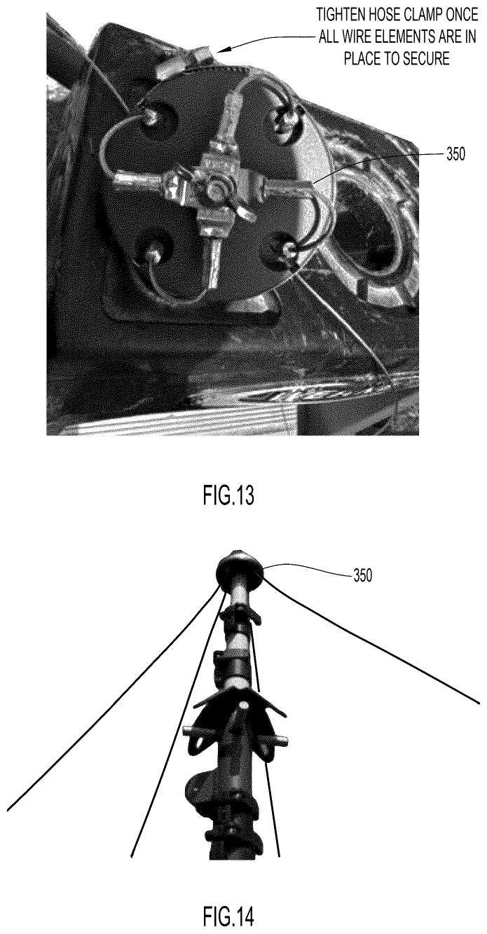

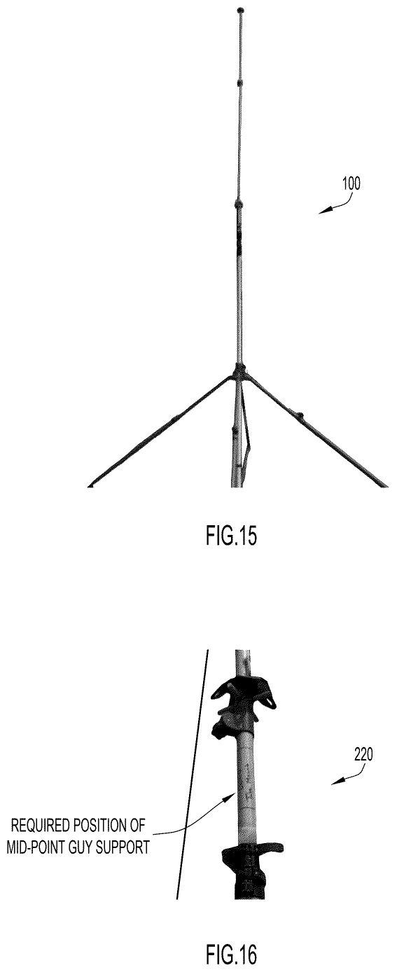

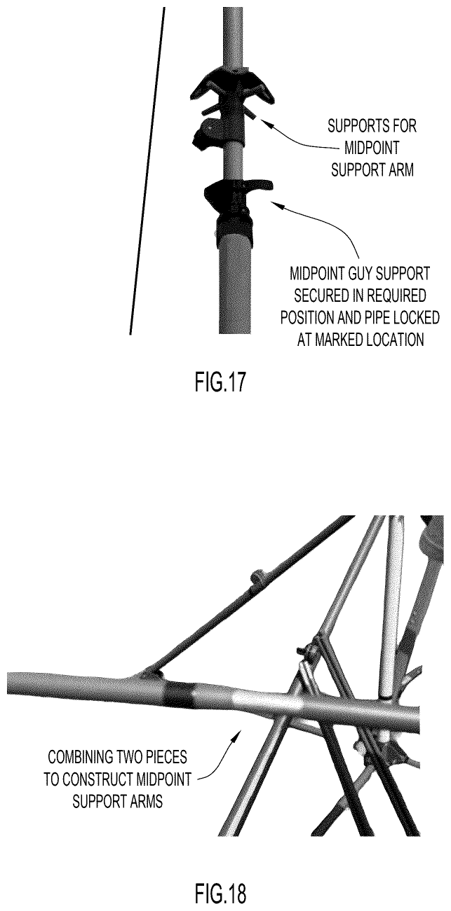

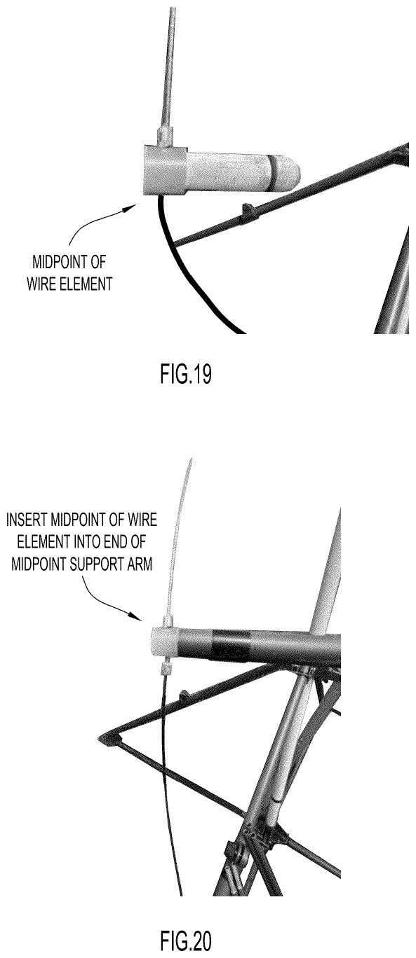

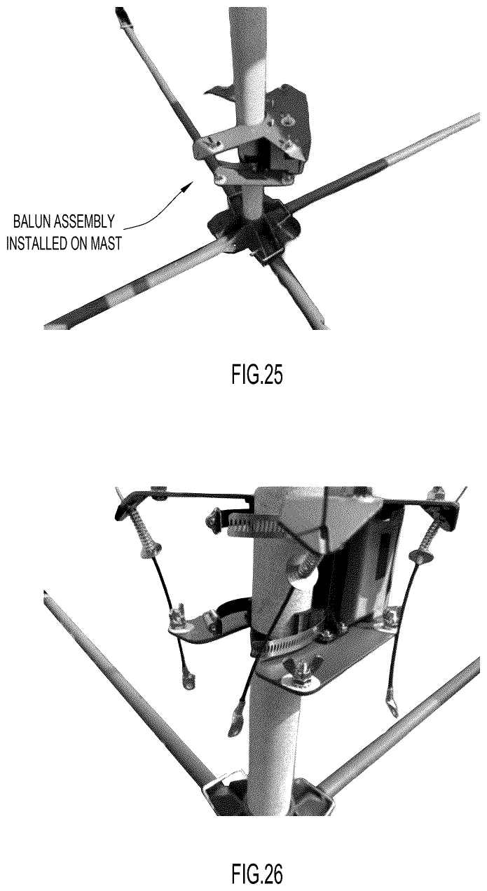

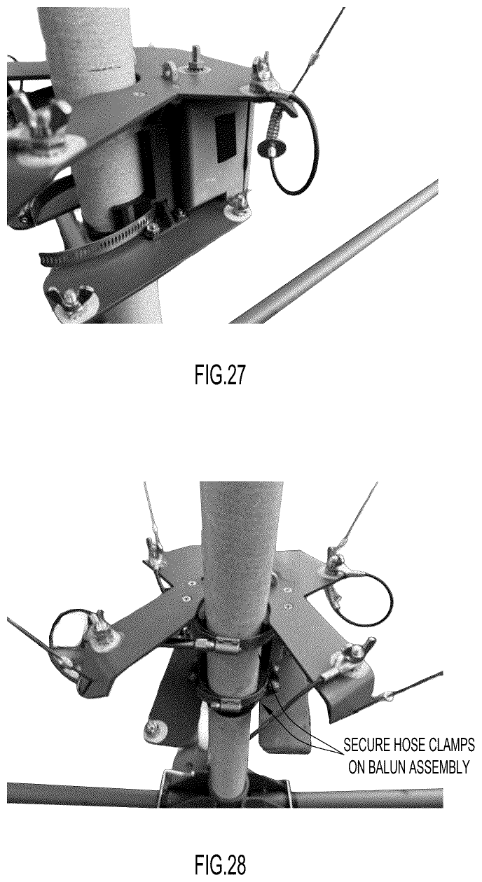

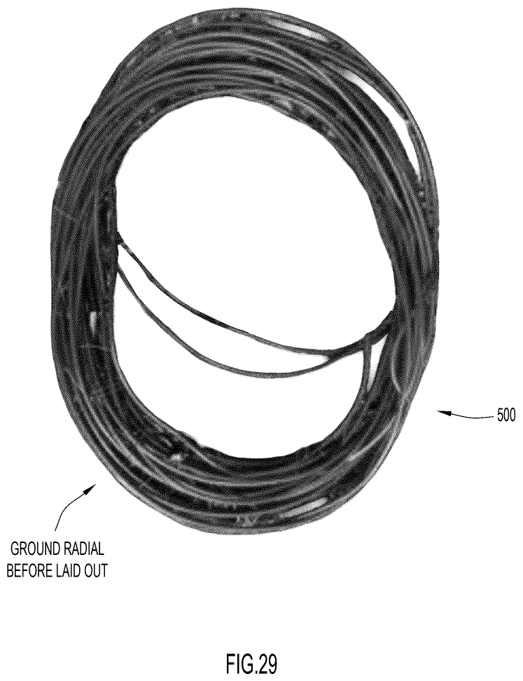

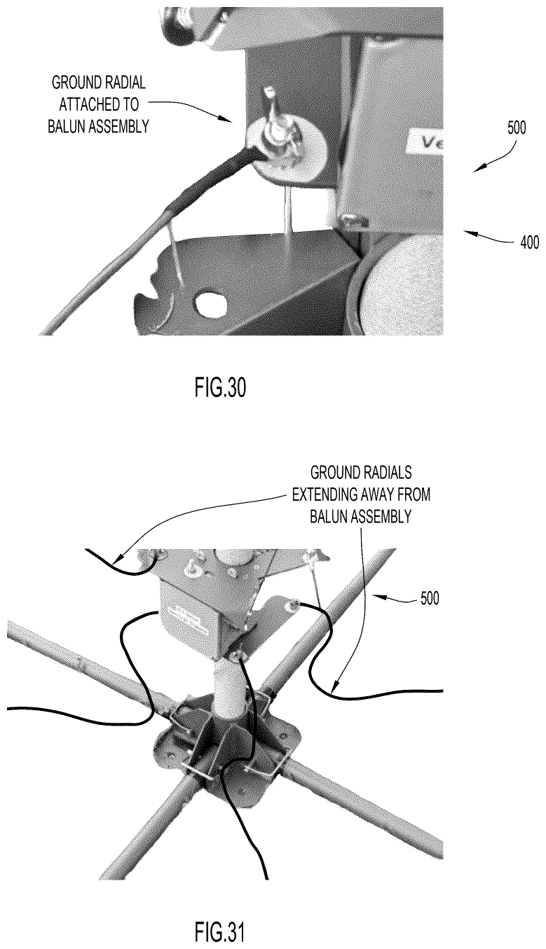

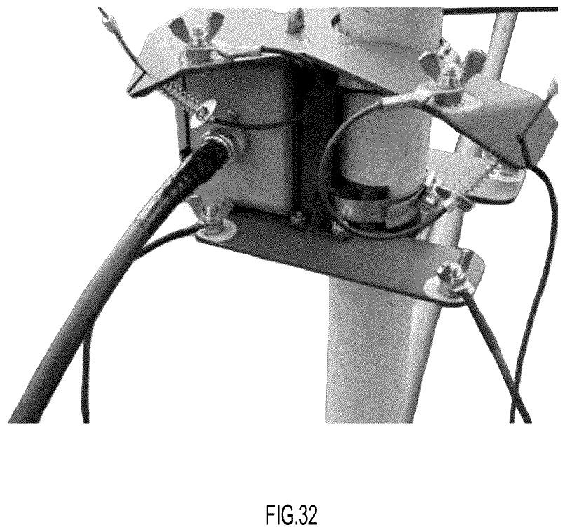

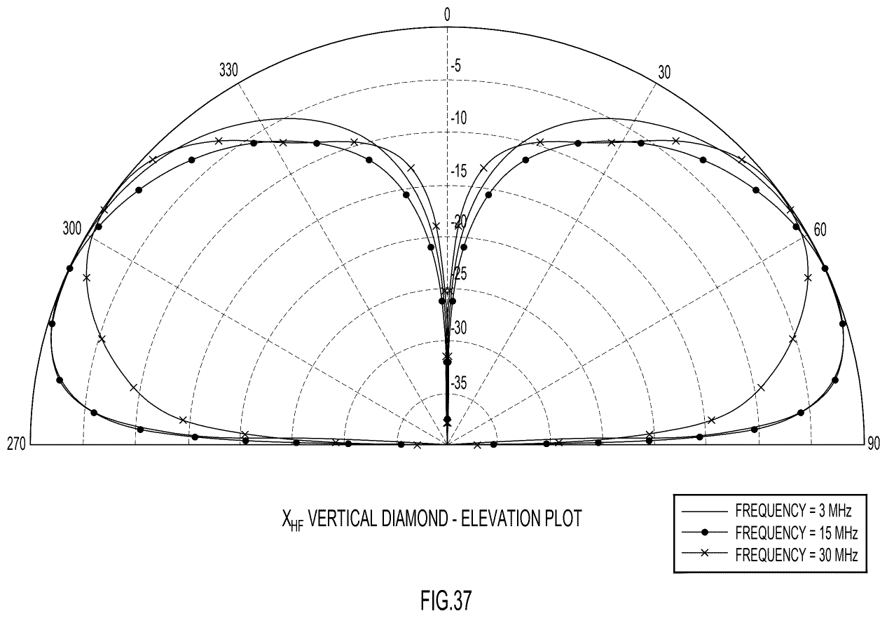

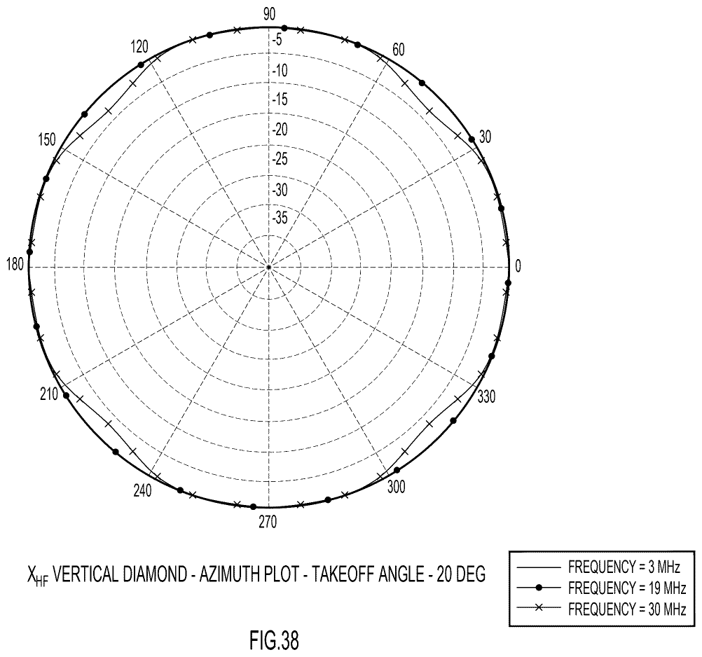

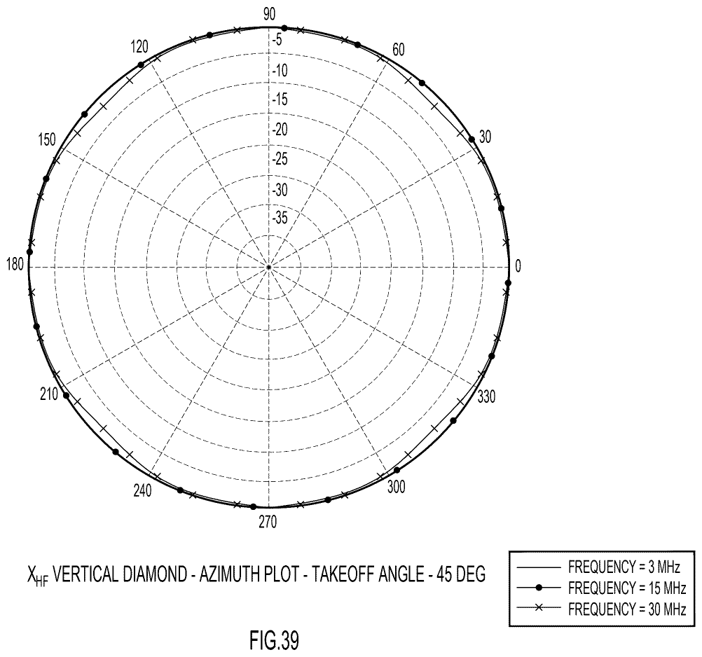

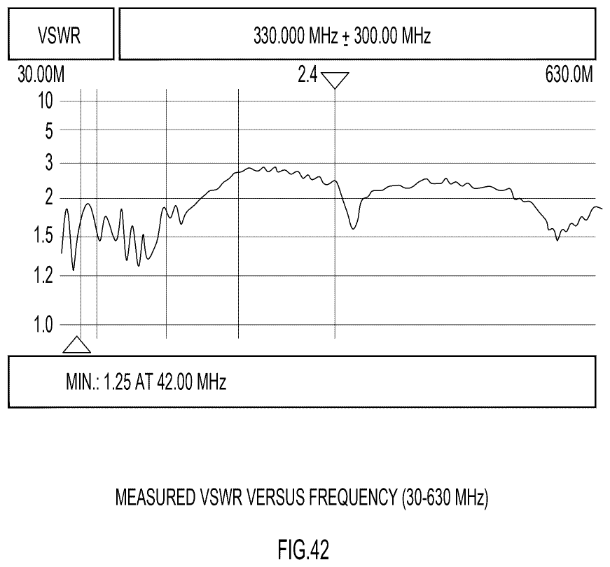

The illustrated embodiments will be best understood by reference to the drawings (FIGS. 2-46), wherein like parts are designated by like numerals throughout. The following description is intended only by way of example, and illustrates certain selected embodiments of methods, devices, assemblies, apparatus, systems, products, modules, submodules, etc. that are consistent with the embodiments as received in the accompanying claims.

Reference throughout this specification to “a select embodiment,” “one embodiment,” “an exemplary embodiment,” “exemplary embodiments,” “an embodiment,” “embodiments,” or the like means that a particular feature, structure, or characteristic described in connection with the embodiment(s) is included in at least one embodiment. Thus, appearances of the phrases “in a select embodiment,” “in one embodiment,” “in an exemplary embodiment,” “in exemplary embodiments,” “in an embodiment,” “in embodiments,” or the like in various places throughout this specification are not necessarily referring to the same embodiment(s) or only a single embodiment. The embodiments may be, for example, combined with one another in various combinations and modified to include features of one another.

Generally, one or more exemplary embodiments described herein provide systems, products and other articles, and processes and methods of transporting, erecting and using an antenna system in a particular expeditionary location or other environment through the use of assemblies of antenna and radio components or the like that would otherwise be unobtainable or extremely difficult, impractical, and/or expensive. Ideally, execution or implementation of one or more exemplary embodiments enables an expeditionary communication system user to transport, assemble, erect and use their antenna system in very challenging locations and operational conditions.

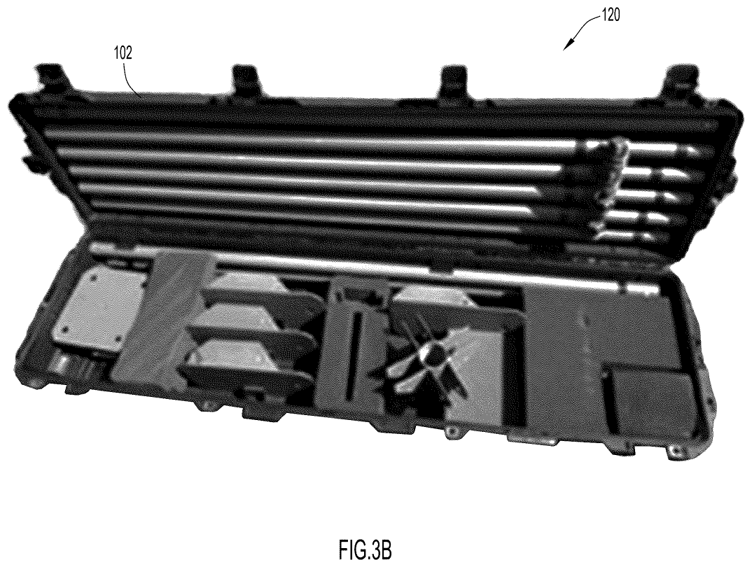

The development of the Vertical Diamond HF/multiband (“X_{MB}”) antenna system 100 of the present invention was accomplished in two stages, where surprisingly effective performance characteristics were discovered. Referring to FIGS. 2-46, transportable X_{MB} vertical diamond antenna system 100 of the present invention comprises a kit (“the X_{MB} kit”) with disassembled components packed, preferably, in three carrying cases (e.g., 102 shown with the disassembled base 120) and consists of five primary components: 1) base 120, 2) mast 200, 3) antenna assembly 300, 4) new balun matching transformer assembly 400 and 5) ground plane radials 500. The base 120 is a quad-leg system that sits on the ground (see FIG. 2B) and holds the mast 200 of the system. Base 120 consists of a number of both commercial-off-the-shelf (COTS) and custom-built parts (121-128, as seen in FIG. 3A). The mast 200 may be a COTS telescoping fiberglass pole or a multi-segment pole assembly that provides support for and orients the antenna assembly 300.

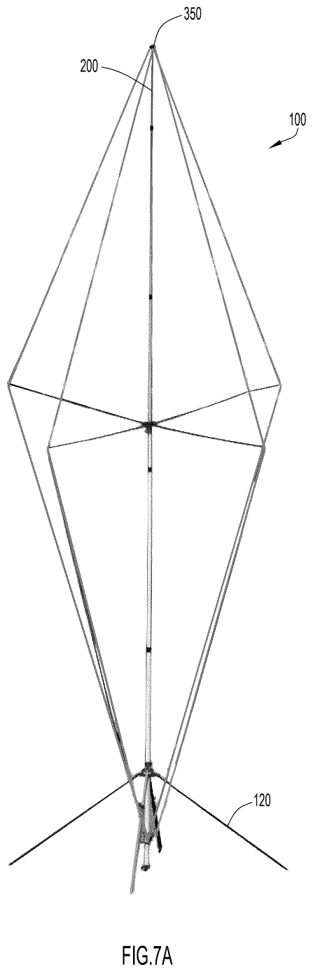

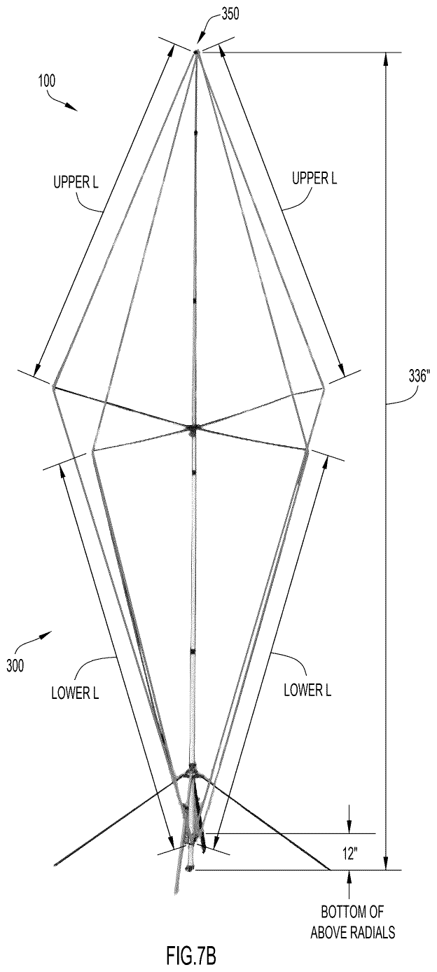

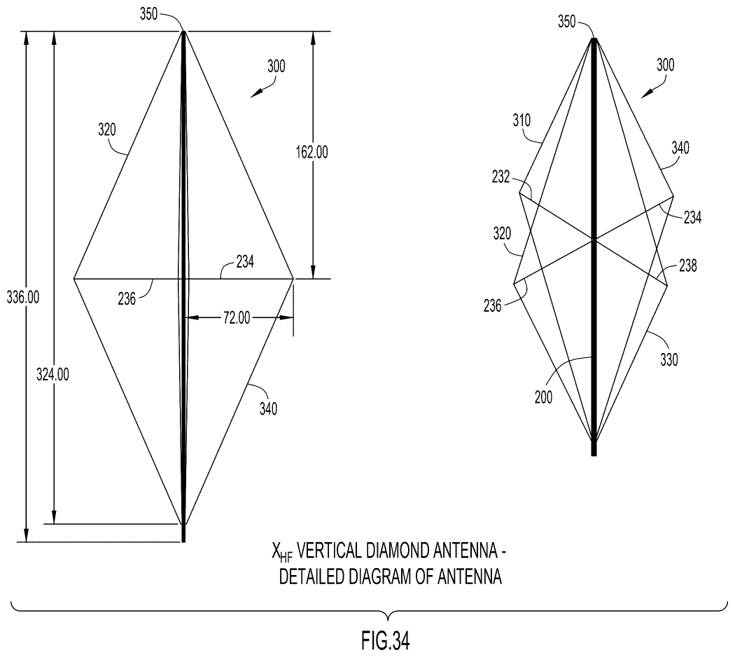

Antenna assembly 300 comprises a series of four inter-connecting electrically conductive metal alloy (e.g., steel) wires (e.g., four wire elements 310, 320, 330 and 340) and supporting structural elements. The antenna wire elements 310, 320, 330 and 340 are preferably 1/16 inch diameter steel wire segments of a selected wire element length and are included in the X_{MB} kit with terminations on both ends with conductive fittings or releasable connectors made from a metal alloy, and including, on each wire segment, a tension spring (see, e.g., FIGS. 8-14). Once erected, the dimensions and spacings of the orthogonally offset first and second vertical diamond antenna elements are as illustrated in FIGS. 7A, 7B and 34, where a first diamond shaped antenna element is defined in a first plane by wire elements 310 and 330 with opposing lateral apexes aligned along an axis defined by midpoint support arms 232 and 238. A second diamond shaped antenna element is defined in a second plane which is orthogonal to the first plane by wire elements 320 and 340 with opposing lateral apexes aligned along a second orthogonal axis defined by midpoint support arms 236 and 234 (e.g., as best seen in the side view of FIG. 34).

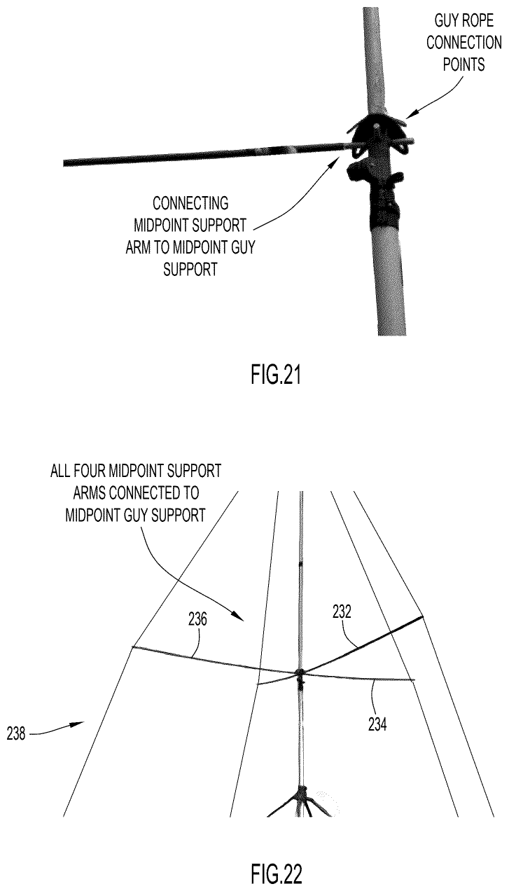

In the illustrated embodiments, mast 200 is a telescoping fiberglass pole with coaxially nested hollow sections which are manually lockable or releasable once extended to a desired length. The mast 200 and midpoint support arms 232, 234, 236 and 238 define the diamond shape and configuration of the conductive elements for antenna 300 (e.g., as seen in FIG. 34). When erected with base 120, mast 200 projects along a substantially vertical axis to a mast height of 28 feet (or 336 inches or 8.5 meters, within a selected tolerance, e.g., + or − one foot or 12 inches or about 31 cm) and supports the antenna's mid-point guy support 220 to a diamond max lateral spread which is 162 inches below the attachment point for top hub assembly 350. The diamond max lateral spread height is aligned within a substantially horizontal plane defined in this example by placement of four orthogonal coplanar midpoint support arms 232, 234, 236, 238 (as shown in FIGS. 21 and 22). The length of each of the equally spaced radially arrayed coplanar midpoint support arms 232, 234, 236, 238 is preferably 72 inches (or 183 cm, within a selected tolerance, e.g., + or − 2 inches or about 3 cm) which defines the maximum lateral width for the diamond shape defined by antenna 300 as 12 feet or 144 inches (within a selected tolerance, e.g., + or − one foot or 12 inches or about 31 cm). Antenna 300 is configured as first and second orthogonal diamond shaped loops having a height defined by mast 120 which carries top hub assembly 350 at a height of 336 inches above the arrayed radial elements 500 (within a selected tolerance, e.g., + or − one foot or 12 inches or about 31 cm).

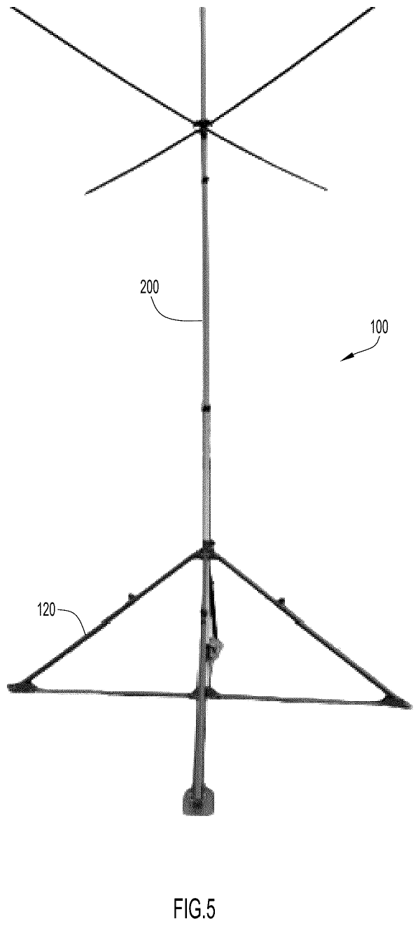

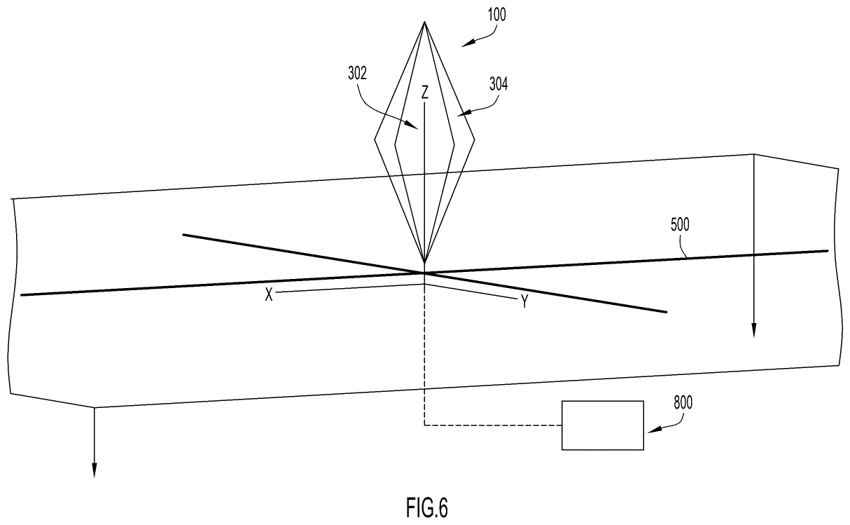

The antenna wire elements 310, 320, 330 and 340 are connected at the top of the mast 200 to an upper antenna wiring assembly 350 (see FIGS. 8-14). Opposing ends of antenna wire elements 310, 320, 330 and 340 are also connected at the bottom of the mast 200 to another (i.e., lower) antenna wiring assembly 360, which connects to or contains the system's balun matching transformer 400 (an electrical device that matches a balanced signal to an unbalanced signal and provides an N-style RF connector where the user can connect a coaxial cable to connect an HF transmission system (e.g., a radio 800 with or without amplifier) to antenna 300. As the radio (e.g., 30 or 800) generates electrical signals, the signals are passed through the coaxial cable into the balun assembly 400, and then fed out into the antenna's wire elements, where the signals are then converted into an electromagnetic field that is propagated into the atmosphere. In the exemplary embodiment, a plurality (e.g., four) ground plane radials 500 (i.e., four radially arrayed 50-ft stretches of wire) project radially or emanate from the lower wiring assembly and preferably lay on the ground (e.g., in a substantially horizontal co-planar orientation) in four perpendicular angles from each other (see FIGS. 6, 29-31). These radial element wires 500 serve to establish a ground plane for the antenna system 300. In the HF band, electromagnetic signals bounce off the Earth's ionosphere and back down to Earth, thus enabling long, medium, and short-range (e.g., NVIS) communications.

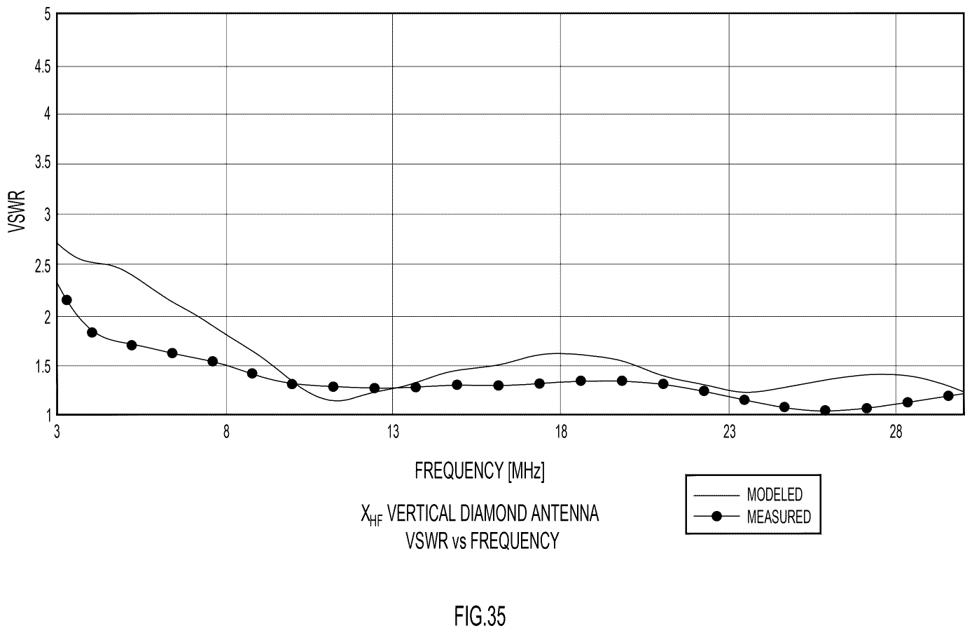

Once erected, the X_{MB} system 100 can instantly receive usable signals over the entire 3-30 MHz HF band without significant variation in performance as a function of azimuth, thus obviating any need for changing azimuth orientation of the antenna. For transmit operations the X_{MB} system 100 has been tested up to transmit powers of over 1000 Watts. For the illustrated prototype system 100, at frequencies below 7 MHz, an attenuator (e.g., a fixed 3-dB attenuator or pad, not shown) should preferably be placed in-line between the radio (e.g., 800) and antenna 300. The 3 dB attenuation pad is preferably rated appropriately for whatever power level is to be transmitted. The 3 dB attenuation pad is not necessarily provided as part of the X_{MB} system 100 as illustrated in the attached figures. For transmit frequencies of 7-30 MHz, a transmitting radio (e.g., 800) can be connected directly to the system 100. In that standard “X_{HF}” embodiment, antenna system 100 performs very well over standard HF frequencies (e.g., 3-30 MHz) as illustrated by the data shown in FIGS. 35-39.

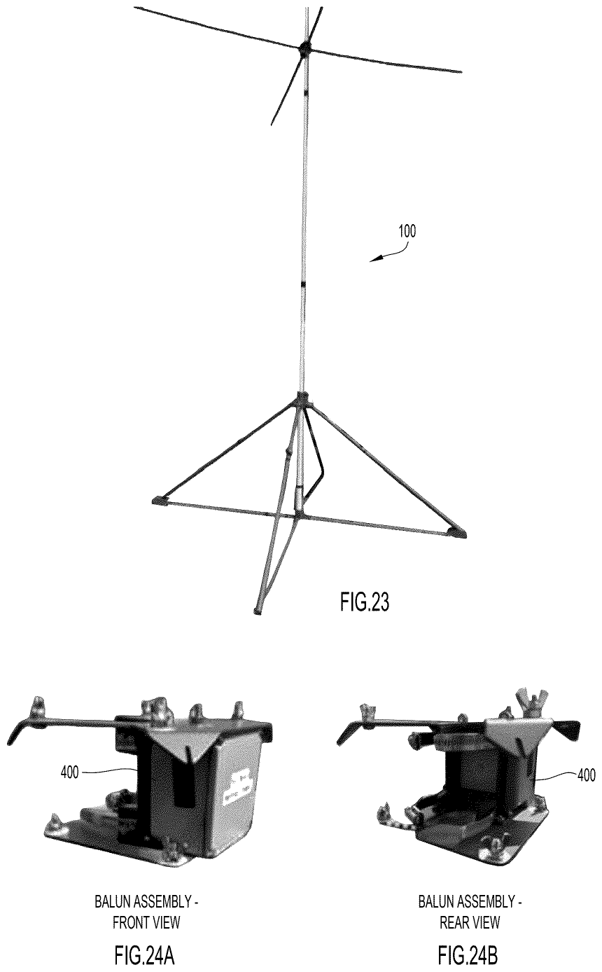

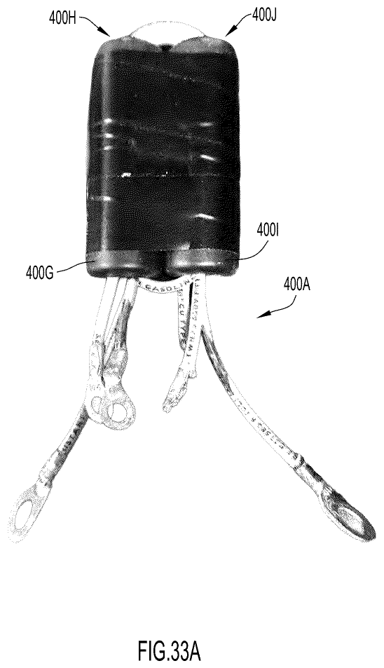

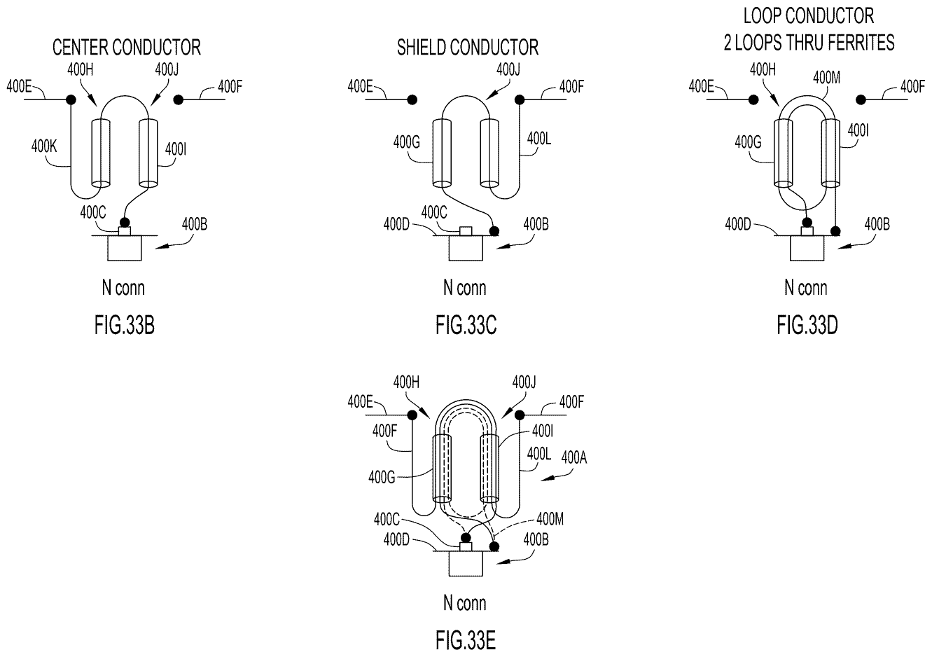

In the illustrated embodiment, balun assembly 400 may include a commercial balun product (e.g., from Palomar Engineers® or Balun Designs®, Model 4113s, which is a 4:1 Current Balun rated at 1.5 to −31 MHz, 3 KW and fitted with a Type N connector) or may include applicants'own new hand-wound 4:1 Balun 400A such as that shown in FIGS. 33A-33E. Applicants'hand wound balun 400A has provided surprisingly improved performance at higher frequencies. Referring again to FIGS. 33A-33E, applicants'new hand-wound balun 400A is contained within the balun assembly housing (as seen in FIGS. 23-26) and has a coaxial “N” connector 400B with a center pin 400C separated by insulation from a conductive shield 400D. Coaxial (e.g., N) connector 400B is a standard coaxial electrical connector which can be connected via a removable cable to a radio (e.g., 30, 800). Balun assembly 400 also has a first antenna element connection 400E and a second antenna element connection 400F.

Hand-wound balun 400A comprises at least a first tubular ferrite segment 400G having a first ferrite lumen 400H therethrough and a second tubular ferrite segment 400I having a second ferrite lumen 400J therethrough. FIG. 33A shows hand-wound balun 400A with first tubular ferrite segment 400G aligned in parallel with and bound to second tubular ferrite segment 400I with three balun winding wire segments (e.g., 400K, 400L, 400M) wound through the first and second parallel ferrite segment lumens 400H, 400J as illustrated in the diagrams of FIGS. 33B-33E. In FIG. 33B, a first hand-wound balun wire segment 400K is connectable to first antenna connection 400E and extends up through first lumen 400H continuing down through lumen 400J and is connected to the center pin 400C of coaxial connector 400B. In FIG. 33C, a second hand-wound balun wire segment 400L is connectable to second antenna connection 400F and extends up through second ferrite lumen 400J continuing down through first ferrite lumen 400H and is connected to the conductive shield 400D of coaxial connector 400B. In FIG. 33C, a third hand-wound balun wire segment 400M is connectable to coaxial connector center pin 400C and extends up through first ferrite lumen 400H continuing down through second ferrite lumen 400J and then loops back to up through first ferrite lumen 400H a second time continuing down through second ferrite lumen 400J a second time where it is then connected to the coaxial connector shield 400D of coaxial connector 400B.

This novel winding method and configuration differs from prior art commercial balun products the applicant has inspected. First balun wire segment 400K makes a single pass up through the first ferrite lumen 400H and down through the second ferrite lumen 400J. Second balun wire segment 400L makes a single pass up through the second ferrite lumen 400J and down through the first ferrite lumen 400H, so those wire segments 400K, 400L provide first and second parallel lengths of wire in each ferrite lumen and alternating currents through first balun wire segment 400K create moving H fields which are equal in magnitude to and opposite direction from the currents and H field from second balun wire segment 400L, while the double loop of third balun wire segment 400M provides third and fourth parallel lengths of wire in those first and second ferrite lumens 400H, 400J, as best seen in the diagram of FIG. 33E. The first or second tubular ferrite segments 400G, 400I can each comprise two or more short lengths of tubular ferrite with coaxially aligned lumens, which, when aligned and bound together, resemble and function like the embodiment of FIGS. 33A-33E.

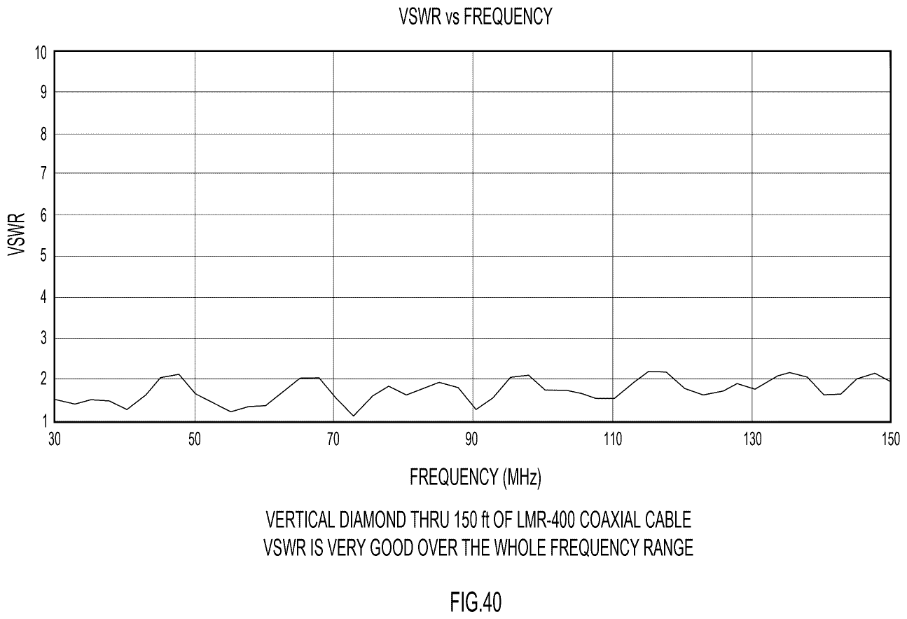

The performance of X_{MB} antenna system 100 with new hand wound balun 400A came as a surprising improvement over applicants'original X_{HF} antenna work. The improved performance at higher frequencies is illustrated in FIGS. 40-46. The commercial balun applicants were using in the original X_{HF} embodiment of the present invention (i.e., a 4:1 balun from Palomar Engineers®) was discontinued, and rather than perpetually chasing new vendors, applicants decided to build their own 4:1 Balun (e.g., 400A) using the same enclosure, but with new hand-wound windings made and assembled in-house. By using applicants'new balun 400A as part of a balun assembly 400 mountable on the antenna mast in prototype testing, it was discovered that applicants'antenna system attained surprisingly good and uniform multi-band performance (in VHF and UHF). After this surprising discovery, applicants went back and performed testing on one of applicants'original X_{HF} antenna systems, and while it works in these bands, it does not perform in VHF and UHF nearly as well as the new X_{MB} antenna system when equipped with applicants'new balun 400A.

Applicants subsequent study of this surprising multi-band performance (e.g., as illustrated in FIGS. 40-46) revealed that in the X_{MB} embodiment of the antenna system 100, the new balun assembly 400 with balun 400A works with the Diamond shape of the first and second planar antenna elements at the element's bend points (i.e., the middle bend of the diamond at the ends of midpoint support arms (232, 234, 236, and 238)) and the wire element bend bottom where each wire element sharply bends as it's fitted into the slots that hold it in place and curls back to the connection points), these parts of each wire element provide the wire element geometry to allow surprisingly effective antenna performance in these higher than HF bands (e.g., as seen in FIGS. 40-46). The new balun design 400A accentuates this characteristic. The new Balun 400A is still a 4:1 Balun, but the windings are different than in the commercial product.

The in the illustrated example, mast 200 is a MK-6-STD mast, which is a 32 feet long standard-duty fiberglass push-up mast. And as seen in the user manual photographs and diagrams of FIGS. 2A-32, components from the X_{MB} kit are assembled and attached to mast 200 is a defined sequence before mast 200 is raised to its full height.

The concept for the X_{HF} and X_{MB} embodiments of antenna system 100 was born in an analysis and modeling task conducted related to development of a prototype military concept where many HF antennas are interconnected into a “hub” (not shown) that can act as a gateway for local HF users and provide robust long-distance relaying for those local users. This concept would allow a local user to reduce their own transmit power and make themselves more difficult to detect by an enemy force. The small size, easy transportability, rapid setup and wide bandwidth of the antenna system 100 enables antenna array applications that might not be practical with larger antenna or antenna systems with more narrow supported bandwidths. These features enable users to employ advanced communications concepts commonly seen in higher-band communications systems, such as Multiple Input, Multiple Output (MIMO) and beamforming/electronic beam steering applications.

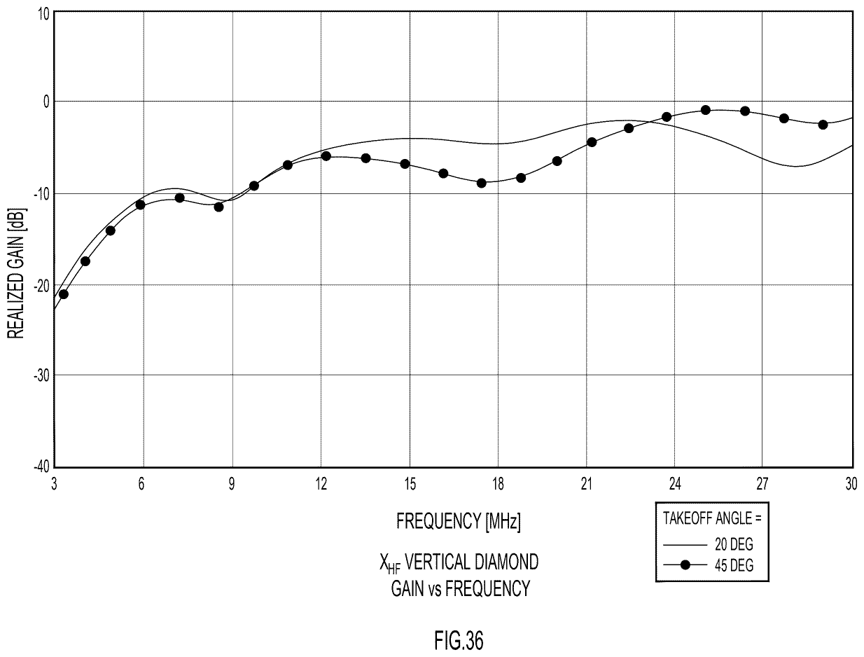

During testing and evaluation of candidate constituent antennas for this prototype hub concept, the applicants observed significant performance issues and limitations. During these analysis efforts, applicants developed computer models of many hypothetical antennas of various shapes, sizes, materials, etc., and modeled their potential performance. Applicants began evaluating a novel conceptual approach to a high-performance, small antenna and refined a design for a potential antenna within the FEKO simulation environment (see, e.g., FIG. 6). After extensive optimization and trial-and-error analysis, applicants converged on a promising design optimized at various low and medium takeoff angles over selected frequencies to provide a very smooth behavior with no dropouts (e.g., impedance or radiation pattern anomalies at some frequencies) that other antennas exhibit. This allows for constant good performance at any frequency for long, medium, and shorter haul communications (e.g., as illustrated in the attached figures). A first prototype of the X_{HF} antenna design was tested and protype performance issues were observed. These test data were fed back to further refine the design of the antenna. This prototype refinement process was iterated numerous times until the developers of the present invention converged on the X_{HF} design described and illustrated in this application. Several additional design iterations were then conducted to refine the mechanical design and setup method of the system. The antenna modeled SWR performance and measured performance for the prototype antenna 300 are illustrated in FIG. 35 and antenna pattern (gain) plots for varying azimuth and vertical takeoff angles are illustrated in FIGS. 36, 37, 38 and 39.

The modelling and measured performance data plotted and illustrated in FIGS. 35-39 for X_{HF} vertical diamond antenna system 100 shows surprisingly better performance than prior art antenna systems, because antenna system 100 is significantly smaller in size and easier to transport and set up than competitor HF antennas while also providing much more consistent gain and VSWR performance across the 3-30 MHz HF frequency band compared to other HF antennas. Antenna system 100 provides much higher bandwidth than other HF antenna systems and does not require any external tuner. The system of the present invention is far simpler to erect configure, tune and use than other HF antennas and can be installed in a much shorter time. The system is much lower cost than comparable HF antennas (comparable in terms of capability). The XHF system is the only known HF system that provides the selected beam pattern, gain and wide operating bandwidth required for modern communication systems in a small, simple form factor.

Persons of skill in the art will recognize that X_{HF} system 100 makes available an easily transportable rapidly deployable High-Frequency (HF) antenna system having a Base 120, a Mast 200 removably attachable to said base, and an Antenna 300 connected to a Balun Matching Transformer assembly 400 and a plurality of radially projecting elements 500 defining a ground plane. The Antenna system 100, when deployed and erected, defines a diamond-shaped array of antenna elements which can be employed to project and receive HF signals in a selected radiation pattern having a selected main beam shape and providing a selected gain over a selected frequency band. For operations at a selected lower HF band limit (e.g., at transmit frequencies below 7 MHz), a fixed 3-dB attenuator (i.e., pad) can be placed in-line between the radio (e.g., 30 or 800) and antenna 300. Without such a pad, an excessive Voltage Standing Wave Ratio (VSWR) may cause significant reflected power which could place radio equipment (e.g., 30 or 800) at risk if not configured to deal with this reflected power.

Vertical Diamond XHF antenna system thus provides a number of advances and improvements over prior art transportable HF antenna systems, including:
(a) Novelty of Mechanical Design: Through the careful but unconventional integration of commercial-off-the-shelf and custom-designed hardware (COTS) components, the XHF vertical diamond antenna system 100 can be packaged into a form factor that enables easy transportation, and enables ease of installation by a minimal number of people in a short amount of time.
(b) Reduced Size: Through its novel electrical design, the XHF vertical diamond antenna system is much smaller than HF antennas providing comparable performance;
(c) Increased Bandwidth for Wideband HF Operations: Through its novel electrical design, the XHF antenna system provides significantly higher instantaneous bandwidth compared to any other HF antenna over most of the HF frequency range without the addition of lossy lumped elements such as resistors. For transmit operations, the XHF vertical diamond antenna system instantaneously supports the 3-7 MHz band with an optional device and the 7-30 MHz band as designed. For receive operations, the XHF vertical diamond antenna system supports instantaneous receive across the entire 3-30 MHz band;
(d) Near-Constant VSWR Performance over entire HF Band: Referring next to FIGS. 35-39, through its novel electrical design, the XHF vertical diamond antenna system 100 provides near-constant and low Voltage Standing Wave Ratio (VSWR) performance across the entire 3-30 MHz frequency band, avoiding “notches” or “nulls” (gaps in performance) common in other HF antenna systems;
(e) Near-Constant Gain Performance over entire HF Band: Through its novel electrical design, the XHF vertical diamond antenna system provides near-constant gain performance across the entire 3-30 MHz frequency band, avoiding gaps in performance common in other HF antenna systems; and
(f) Near-Constant Antenna Radiation Pattern over entire HF Band: Through its novel electrical design, the XHF vertical diamond antenna system provides near-constant radiation pattern across the entire 3-30 MHz frequency band, avoiding “notches” or “nulls” (gaps in performance) common in other HF antenna systems.

Many of these newly developed capabilities arise from operational problems with prior art, where HF communications can be unreliable and hard to predict, making it less usable to users than it could be. Part of this is because of the changing nature of the Ionosphere and RF propagation, which cannot be controlled. Prior art antennas were unsatisfactory due to variation in antenna performance across frequency in VSWR, gain, and changing radiation patterns. Antenna system 100 provides a relatively constant performance experience, taking the guesswork out of it for the user and helping make HF communications more reliable.

The X_{MB} embodiment of the vertical diamond antenna system 100 of the present invention, improved higher frequency performance is illustrated in FIGS. 40-46. After applicants'initial X_{HF} prototype was configured, confidential internal testing in a remote, mountainous location was undertaken, and in that later internal testing, applicants discovered an unknown and surprising capability of their antenna system to support communication with distant installations at higher than HF frequency bands. Specifically what applicants are now referring to as the X_{MB} embodiment of vertical diamond antenna system 100 demonstrated surprising performance when transmitting in the Very High Frequency (VHF) and Ultra High Frequency (UHF) frequency bands, up to a practical operating upper frequency of 500 MHz. More specifically, it was determined (in confidential prototype testing) that the X_{MB} antenna system 100 of the present invention supports both transmit and receive operations across the entire 30-500 MHz HF, VHF and lower UHF bands.

Recent work has revealed that the Multi-Band eXpeditionary “X_{MB}” Vertical Diamond Antenna System 100 provides excellent uniform radiation and VSWR impedance matching for the entire HF and VHF frequency bands, as well as part of the UHF band: Turning now to FIGS. 40-46, as noted above, applicants discovered that their prototype antenna 300 and system 100 can be configured with transmit/receiving equipment to function in a surprisingly effective new multi-band (HF/VHF/UHF) method which provides substantial improvements in expeditionary wireless communication applications, in accordance with the present invention.

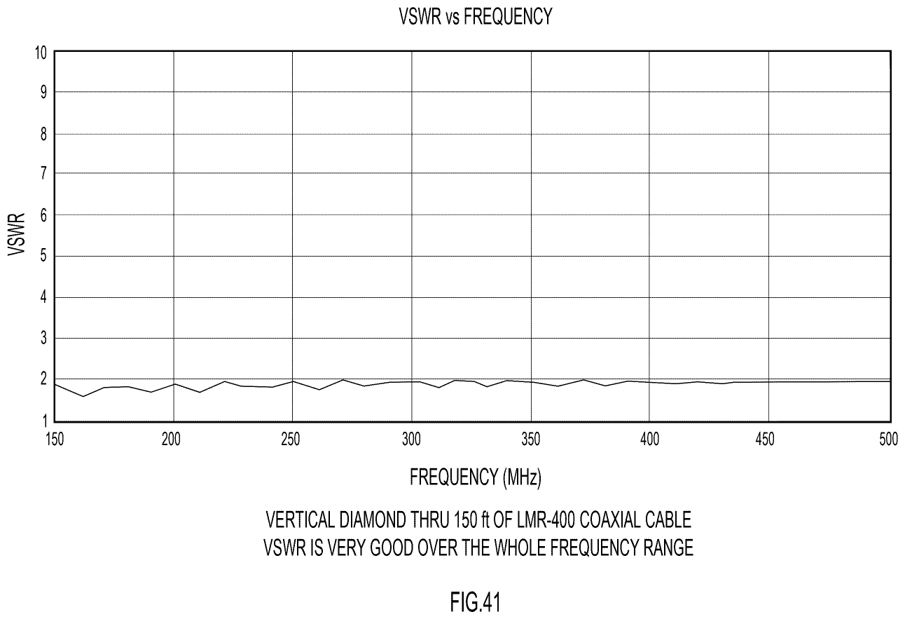

Transportable rapidly deployable eXpeditionary Multi-Band (XMB) antenna system 100 provides wideband, global communications (transmit and receive) in the 3-30 MHz HF frequency band, the Very High Frequency (VHF) frequency band (30-300 MHz), and the lower portion of the Ultra High Frequency (UHF) frequency band (up to 500 MHz). Applicants'X_{MB} antenna, which supports the contiguous 3-500 MHz frequency band, was originally designed to provide support in the 3-30 MHz band in a highly portable, easily setup form factor (see, e.g., commonly owned USPTO application number 63/766,170, incorporated herein by reference in its entirety). The X_{MB} antenna 300, once unpacked and erected, is a Vertical Diamond antenna design. As seen in FIGS. 40 and 41 connecting Antenna system 300 to an HF/VHF/UHF capable radio or transceiver to project and receive signals in an operating frequency band of 30-500 MHz provides an operating VSWR over that operating frequency band of 30-500 MHz of not greater than 3, and preferably less than 2.2. As noted above, Antenna 300 comprising first and second orthogonal diamond-shaped loops including wire antenna elements 310, 320, 330 and 340 (see, e.g., FIGS. 7B and 34) where each of the first and second diamond shaped loops are configured with upper and lower Vee-shaped or angled inter-element gaps that are oriented to project and receive RF signals across an operating frequency range of 3-500 MHz in a selected radiation pattern having a selected main beam shape and providing a selected gain, main beam or antenna radiation pattern over a selected frequency band.

The X_{MB} antenna 300 supports instantaneous reception across the entire 3-30 MHz HF frequency band without the use of any external Radio Frequency (RF) components. The X_{MB} antenna supports a 30 minute setup (for expeditionary users) orienting the antenna in any azimuth and then provides virtually instantaneous signal reception or transmission in the 7-30 MHz HF frequency band without the use of any external RF components and without requiring users to re-aim or adjust the antenna system 100 toward any particular azimuth. The X_{MB} antenna supports transmit capabilities in the 3-7 MHz HF frequency band by adding an external fixed 3 dB attenuation (properly rated for the power output of the radio system in use by the operator) or an antenna tuner/coupler inline between the radio and antenna system. However, applicants have found experimentally that when using the antenna through 100-feet of RF cable between the antenna and radio, that no such pad is generally required unless operating very close to 3 MHz.

The X_{MB} embodiment of the present invention employs substantially the same antenna as the eXpeditionary HF (X_{HF}) Vertical Diamond antenna embodiment so, apart from the new balun 400A, both are described above and illustrated in FIGS. 2-32 and 34.

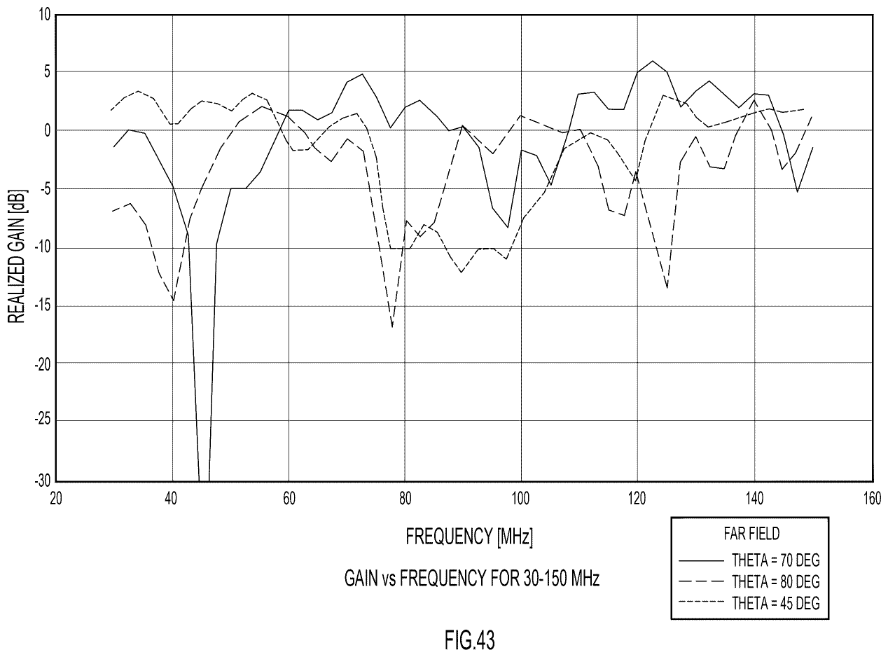

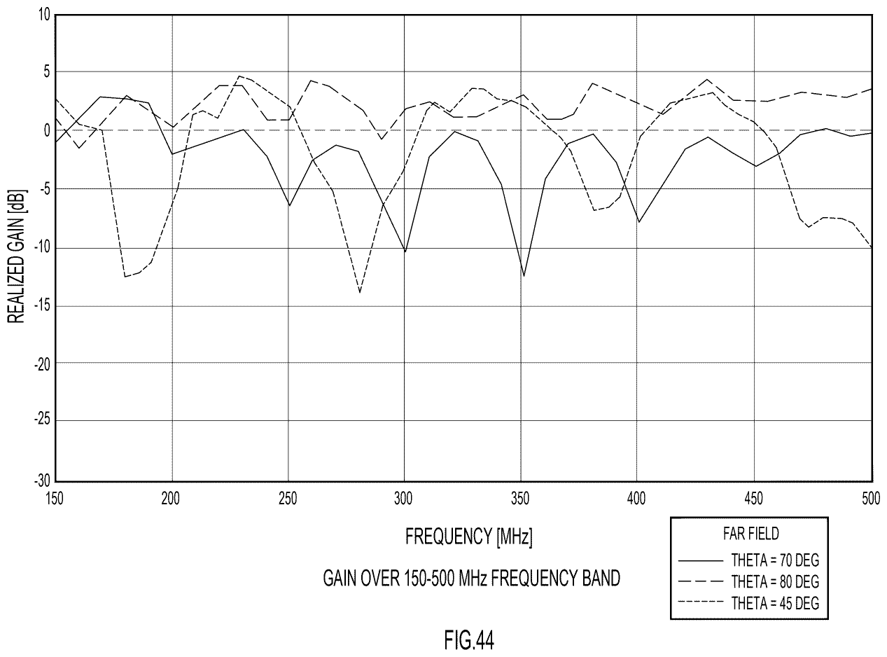

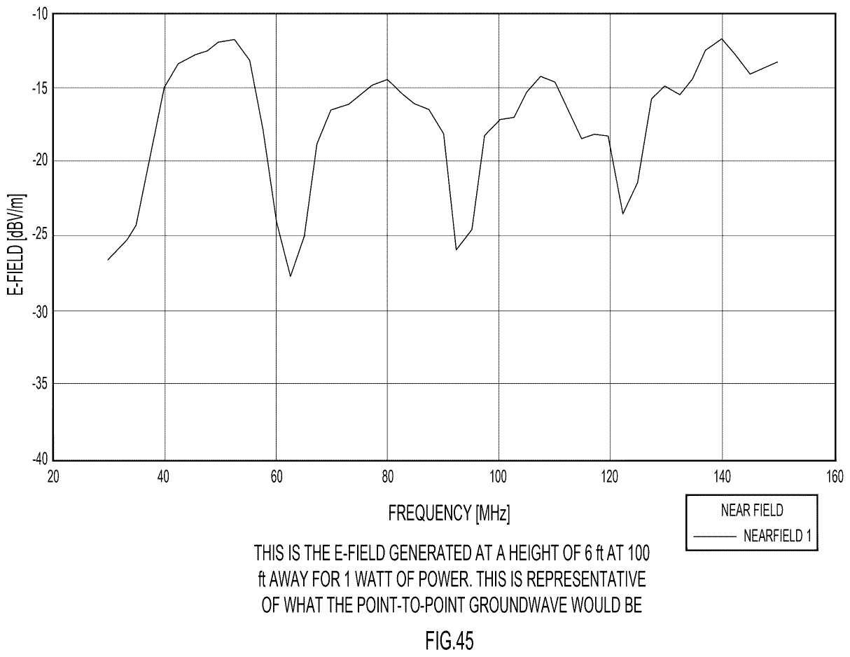

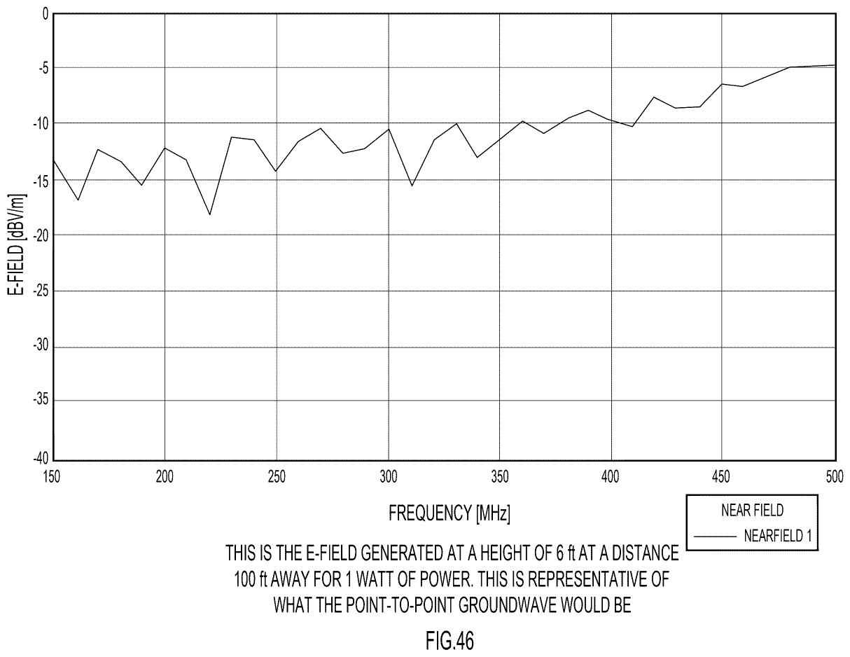

After the surprising performance discovered in the confidential prototype testing, modelling and analysis were undertaken to better understand the VHF and UHF performance measurements, which included (a) VSWR over the broader frequency range (see, e.g., FIGS. 40, 41 and 42), (b) Gain at selected angles over the broader frequency range (see, e.g., FIGS. 43 and 44), and the E-Field generated over the broader frequency range (see, e.g., FIGS. 45 and 46). As best seen in FIGS. 7B, 8 and 34, the antenna elements (Upper L, Lower L segments defined by wire segments 310, 320, 330, 340) and the geometry and placement of the elements were optimized for 3-30 MHz HF performance. However, the physical implementation of the antenna is what applicants deduced has led to this unexpected above HF band (VHF and UHF, 30-500 MHz) support. The antenna elements (Upper L, Lower L segments defined by wire segments 310, 320, 330, and 340) come together in very sharp points at the top hub assembly (see, e.g., 350) and bottom of the antenna assembly, primarily due to the physical design of the system 100. These sharp points and the deflection angles of the wire elements at the midpoint support arms appear to define antenna element spacings which provide efficient radiation in the VHF and UHF frequency bands. So while not intentional, the discovery of the performance of vertical diamond antenna system 100 has unlocked a novel and surprising multi-band transmission capability. These wire element geometry characteristics were discovered to work synergistically with the new hand wound balun design 400A, as described above and illustrated in FIGS. 33A-33E.

The step-by step method for site selection and assembly of the X_{HF} or X_{MB} kit embodiments of antenna system 100 is illustrated in FIGS. 2-32 is preferably provided to the user in a format easily reviewed in the field or while on expedition operations, and may be stored in or transmitted to a portable communication device such as a smart phone, terminal or tablet, optionally configured to work with a dedicated transceiver (not shown). The method and instructions may be stored in memory as part of a computer program stored or transmitted in modules for specific users in specific environments from a portable memory or from cloud-based storage. The user or operator can connect user-selected radio equipment (e.g., 30 or 800) to an N-type coaxial cable fitting connected to the antenna system 100 during installation. While the type of coaxial cable used is up to the user, an exemplary prototype works well with either Times Microwave LMR-400 or LMR-600 as suitable RF cabling solutions. In use with a receiver, The X_{HF} system 100 can simultaneously receive incoming HF signals over the entire 3-30 MHz HF band without significant variation in performance. When used in transmit operations, the X_{HF} system 100 has demonstrated good performance up to transmit powers of 1500 Watts. However, at frequencies below 7 MHz, an optional 3-dB attenuator (i.e., pad) is preferably inserted in-line between the radio and antenna 300. The attenuator pad must be rated appropriately for the application specific transmit power level. For frequencies of 7-30 MHz, a transmitting radio can be connected directly to the system. A tuner can be used between the radio and the antenna assembly 100 if available or built into radio instead of the pad.

Persons of skill in the radio and antenna arts will appreciate that a user guide with pages or sequential screen displays resembling FIGS. 2-32 will be able to assemble any of the exemplary embodiment described above and illustrated in the figures to practice the method of the present invention deploy, assemble, erect and operate the HF or Multi-band (HF, UHF and VHF) vertical diamond antenna system of the present invention by (a) providing a kit with easily carried cases (e.g., 120) containing disassembled antenna system components including a Base assembly 120, a Mast assembly 200 configured to be removably attachable to said base assembly, an Antenna assembly 300 configured to be connected to a Balun Matching Transformer assembly 400 and a plurality of radially projecting Radial elements 500, and then assembling and erecting said base 120 and attaching at least a lower portion of said mast 200. The user or users may then attach the structural components and electrically conductive elements or components 310, 320, 330 and 340 of said antenna assembly 300 to said mast assembly and at least partially extending said mast assembly and configuring said antenna's structural and electrically conductive components to provide a diamond-shaped array (e.g., as seen in FIG. 2A) when mast assembly 200 is fully extended. Another (possibly next) step is connecting said balun matching transformer assembly 400 and the provided (e.g., four to six) radial ground plane defining wires or elements 500 to said antenna assembly and to an HF, UHF or VHF radio or transceiver (e.g., 30) which can be employed to project and receive HF, UHF or VHF signals in a selected radiation pattern having a selected main beam shape and providing a selected gain over a selected frequency band. The step of attaching the structural components and electrically conductive (e.g., steel) wire elements or components 310, 320, 330 and 340 of said antenna assembly 300 to said mast assembly preferably comprises attaching antenna wire elements to a top hub assembly 350 and affixing said top hub assembly carrying connections to said elements or components 310, 320, 330 and 340 to or proximate a top end of said mast assembly, as illustrated in the figures.

In the context of pre-programmed software for use in a communication system with any of the antenna system embodiments (e.g., X_{MB} antenna system 100), the system of the present invention may be configured with a mobile computing or communications device (not shown) including programming to receive, store or display user instructions for assembly or communication operations. The method steps or operations described herein can be programmed as non-transitory program code (e.g., computer-executable instructions, datastores, etc.), which may be stored on one or more tangible, computer-readable storage media that, when executed by one or more processors, perform the recited operations. Generally, computer-executable instructions include routines, programs, objects, components, data structures, and the like that perform particular functions or implement particular abstract data types which may be stored and executed as modules. The order in which the operations are described is not necessarily intended to be construed as a limitation, and any number of the described operations can be combined in any order and/or in parallel to implement the process.

The term “module” refers broadly to locally executed software, software executed in the cloud, hardware, or firmware components (or any combination thereof). Modules are typically functional components that can generate useful data or other output using specified input(s). A module may or may not be self-contained. An application program (also called an “application”) may include one or more modules, or a module may include one or more applications. Generally, modules may include programs, components, objects, routines, logic, data structures, and so on that perform and implement particular tasks. A task may be practiced in distributed cloud computing environments, where tasks are performed by remote processing devices that are linked through a communications network. Modules may be located in a local computer system storage medium/media and/or remote computer system storage medium/media. Modules generally carry out the functions and/or methodologies of embodiments.

Modules may be stored in, for example, memory, operating systems, one or more application programs, other program modules, and program data. The memory may include computer-readable storage media (“CRSM”), which may be any available physical media accessible by the processor to execute instructions stored on the memory. In an implementation, CRSM may include random access memory (“RAM”), flash memory and/or cache memory. In other implementations, CRSM may include, but is not limited to, read-only memory (“ROM”), electrically erasable programmable read-only memory (“EEPROM”), or any other medium which can be used to store the desired information and which can be accessed by the processor.

Computer programs used in an antenna system of the present invention (e.g., X_{MB} Antenna system 100) may be stored in memory, which may be physically present on the system or an external device/system in communication with the system, e.g., so-called “cloud” applications. Computer programs may also be received via a communication interface. Such computer programs, when run, enable the computer system to perform the features of the present embodiments as discussed herein. In particular, the computer programs, when run, enable the processing unit to perform the features of the computer system. Accordingly, such computer programs represent controllers of the computer system. For example, a storage system may be provided for reading from and writing to a non-removable, non-volatile magnetic media (e.g., a hard drive) or other memory. A magnetic disk drive for reading from and writing to a removable, non-volatile magnetic disk (e.g., a disk), and an optical disk drive for reading from or writing to a removable, non-volatile optical disk such as a CD-ROM, DVD-ROM or other optical media can be provided. In such instances, each can be connected to bus by one or more data media interfaces.

Terms “computer program medium,” “computer usable medium,” and “computer-readable medium” are used to generally refer to media such as main memory, including RAM, cache, and storage system, such as a removable storage drive and a hard disk installed in a hard disk drive. Computer-readable storage medium can be a tangible device that can retain and store instructions for use by an instruction execution device. The computer-readable storage medium may be, for example and without limitation, an electronic storage device, a magnetic storage device, an optical storage device, an electromagnetic storage device, a semiconductor storage device, or any suitable combination of the foregoing. A computer-readable storage medium, as used herein, is to be construed as non-transitory, and is not to be construed as being transitory signals per se, whereas the HF (wireless radio analog) signals radiated from and received by the antenna system of the present invention are transitory signals.

While particular embodiments have been shown and described, it will be understood to those skilled in the art that based upon the teachings herein, changes and modifications may be made without departing from its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claims, and in the absence of such recitation no such limitation is present. For non-limiting example, as an aid to understanding, the following appended claims may contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to the embodiments containing only one such element, even when the same claim includes the introductory phrases “one or more” or “at least one” and indefinite articles such as “a” or “an”; the same holds true for the use in the claims of definite articles. As used herein, the term “and/or,” as in “A, B, and/or C,” means either or multiple or all (or any combination or all the terms or expressed referred to), such as: A; B; C; A and B; A and C; B and C; or A, B, and C.

The corresponding structures, materials, acts, and equivalents of all means or step plus function elements which may be included in the claims below are intended to include any structure, material, or act for performing the function in combination with other claim elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiments were chosen and described in order to best explain the principles of the embodiments and the practical application, and to enable others of ordinary skill in the art to understand the embodiments for various embodiments with various modifications and combinations with one another as are suited to the particular use contemplated. Accordingly, the scope of protection of the embodiment(s) is limited only by the following claims and their equivalents.

Having described exemplary and preferred embodiments of new and improved antenna systems and methods, it is believed that other modifications, variations and changes will be suggested to those skilled in the art in view of the teachings set forth herein. It is therefore to be understood that all such variations, modifications and changes are believed to fall within the scope of the present invention as set forth in the appended claims.

1. A transportable rapidly deployable High-Frequency (HF) Vertical Diamond antenna system 100, comprising:
a dual orthogonal plane antenna assembly 300 with a first diamond shaped planar antenna segment 302 and a second diamond shaped planar antenna segment 304 supported upon a substantially vertical support member or mast 200;
wherein said first and second planar antenna segments each comprise conductive diamond shaped loops that terminate at a top end connection member 350 supported on said vertical support member 200 at a vertical height of less than 29 feet;
and wherein said antenna system which provides consistent gain at any azimuth and a Voltage Standing Wave Ratio (VSWR) of less than 3 across the entire HF frequency band and beyond without significant variations in performance over azimuth.

2. The transportable rapidly deployable High-Frequency (HF) Vertical Diamond antenna system of claim 1, wherein said first and second planar antenna segments 300, 302 each comprise a pair of angled upper and lower wire element lengths which define an isosceles triangle with vertical support 200 and supported by horizontal mid-point support arms which project laterally from vertical support 200.

3. The transportable rapidly deployable High-Frequency (HF) Vertical Diamond antenna system of claim 1, wherein said first and second planar diamond shaped antenna segments 300, 302 each comprise a pair of substantially vertical inter-connecting electrically conductive metal alloy (e.g., steel) wires (e.g., two wire elements 320, 340) terminated with conductive fittings or releasable connectors made from a metal alloy.

4. The transportable rapidly deployable High-Frequency (HF) Vertical Diamond antenna system of claim 3, wherein first and second planar diamond shaped antenna segments 300, 302 each is defined in a plane by wire elements (e.g., 320 and 340) with opposing lateral apexes aligned along an axis defined by corresponding midpoint support arms (e.g., 236 and 234).

5. The transportable rapidly deployable High-Frequency (HF) Vertical Diamond antenna system of claim 4, wherein:
when erected with base 120, substantially vertical support member or mast 200 projects along a substantially vertical axis to a mast height of 28 feet (or 336 inches or 8.5 meters, within a selected tolerance, e.g., + or − one foot or 12 inches or about 31 cm) and supports the antenna's mid-point guy support 220 to a diamond max lateral spread which is 162 inches below the attachment point for top hub assembly 350.

6. The transportable rapidly deployable High-Frequency (HF) Vertical Diamond antenna system of claim 5, wherein:
for each diamond shaped loop antenna segment 302, 304 there is a maximum lateral spread at the outer distal ends of the opposing midpoint support arms (e.g., 236 and 234), and wherein the length of each of the equally spaced radially arrayed coplanar midpoint support arms (e.g., 232, 234, 236, 238) is preferably 72 inches (or 183 cm, within a selected tolerance, e.g., + or − 2 inches or about 3 cm) which defines the maximum lateral width for the diamond shape defined by antenna 300 as 12 feet or 144 inches (within a selected tolerance, e.g., + or − one foot or 12 inches or about 31 cm).

7. The transportable rapidly deployable High-Frequency (HF) Vertical Diamond antenna system of claim 1, wherein, when erected with base 120, mast 200 projects along a substantially vertical axis to a mast height of 28 feet (or 336 inches or 8.5 meters, within a selected tolerance, e.g., + or − one foot or 12 inches or about 31 cm) and supports the antenna's mid-point guy support 220 to a diamond max lateral spread which is 162 inches below the attachment point for top hub assembly 350.

8. The transportable rapidly deployable High-Frequency (HF) Vertical Diamond antenna system of claim 7, wherein the diamond max lateral spread height is aligned within a substantially horizontal plane defined by placement of four orthogonal laterally projecting coplanar midpoint support arms 232, 234, 236, 238 each having a length of 72 inches (or 183 cm, within a selected tolerance, e.g., + or − 2 inches or about 3 cm) which defines the maximum lateral width for the diamond shape defined by antenna 300 as 12 feet or 144 inches (within a selected tolerance, e.g., + or − one foot or 12 inches or about 31 cm).

9. The transportable rapidly deployable High-Frequency (HF) Vertical Diamond antenna system of claim 1, wherein a plurality (e.g. four) ground plane radials 500 (i.e., four radially arrayed 50-ft stretches of wire) project radially or emanate from the lower wiring assembly and preferably lay on the ground (e.g., in a substantially horizontal co-planar orientation) in evenly spaced (e.g., four perpendicular) angles from each other (see FIGS. 6, 29-31 and 33) and said radial element wires 500 serve to establish a ground plane for the antenna system 300.

10. The transportable rapidly deployable High-Frequency (HF) Vertical Diamond antenna system of claim 1, wherein, once erected with midpoint support arms (e.g., 236 and 234) pointed in any azimuth direction, antenna system 100 can instantly receive usable signals over the entire 3-30 MHz HF band without significant variation in performance as a function of azimuth, thus obviating any need for changing azimuth orientation of the antenna.

11. The transportable rapidly deployable High-Frequency (HF) Vertical Diamond antenna system of claim 1, wherein said first and second planar antenna segments 300, 302 comprise conductive elements 310, 320, 330 and 340 connected to a Balun Matching Transformer assembly 400 and configured to operate over a ground plane preferably with plurality of projecting Radial elements 500;
wherein said Antenna, when deployed and erected defines a diamond-shaped array of antenna elements 310, 320, 330 and 340 defining first and second orthogonal loops (see, e.g., FIG. 34) which can be employed to project and receive HF signals in a selected radiation pattern having a selected main beam shape and providing a selected gain, main beam or antenna radiation pattern over a selected frequency band.

12. A transportable rapidly deployable Multi-band (HF, UHF and VHF) Vertical Diamond antenna system 100, comprising:
a dual orthogonal plane antenna assembly 300 with a first diamond shaped planar antenna segment 302 and a second diamond shaped planar antenna segment 304 supported upon a substantially vertical support member or mast 200;
wherein said first and second planar antenna segments each comprise conductive diamond shaped loops that terminate at a top end connection member 350 supported on said vertical support member 200 at a vertical height of less than 29 feet; and
wherein said antenna system which provides consistent gain at any azimuth and a Voltage Standing Wave Ratio (VSWR) of less than 3 across the entire HF frequency band and beyond without significant variations in performance over azimuth.

13. The transportable rapidly deployable Multi-band (HF, UHF and VHF) Vertical Diamond antenna system of claim 12, wherein, when erected with base 120, mast 200 projects along a substantially vertical axis to a mast height of 28 feet (or 336 inches or 8.5 meters, within a selected tolerance, e.g., + or − one foot or 12 inches or about 31 cm) and supports the antenna's mid-point guy support 220 to a diamond max lateral spread which is 162 inches below the attachment point for top hub assembly 350.

14. The transportable rapidly deployable Multi-band (HF, UHF and VHF) Vertical Diamond antenna system of claim 13, wherein the diamond max lateral spread height is aligned within a substantially horizontal plane defined by placement of four orthogonal laterally projecting coplanar midpoint support arms 232, 234, 236, 238 each having a length of 72 inches (or 183 cm, within a selected tolerance, e.g., + or − 2 inches or about 3 cm) which defines the maximum lateral width for the diamond shape defined by antenna 300 as 12 feet or 144 inches (within a selected tolerance, e.g., + or − one foot or 12 inches or about 31 cm).

15. The transportable rapidly deployable Multi-band (HF, UHF and VHF) Vertical Diamond antenna system of claim 12, wherein a plurality (e.g. four) ground plane radials 500 (i.e., four radially arrayed 50-ft stretches of wire) project radially or emanate from the lower wiring assembly and preferably lay on the ground (e.g., in a substantially horizontal co-planar orientation) in evenly spaced (e.g., four perpendicular) angles from each other (see FIGS. 6, 29-31 and 33) and said radial element wires 500 serve to establish a ground plane for the antenna system 300.

16. The transportable rapidly deployable Multi-band (HF, UHF and VHF) Vertical Diamond antenna system of claim 12, wherein, once erected with midpoint support arms (e.g., 236 and 234) pointed in any azimuth direction, antenna system 100 can instantly receive usable signals over the entire 3-30 MHz HF band without significant variation in performance as a function of azimuth, thus obviating any need for changing azimuth orientation of the antenna.

17. The transportable rapidly deployable Multi-band (HF, UHF and VHF) Vertical Diamond antenna system of claim 12, further comprising a balun assembly 400 configured for connection said a first diamond shaped planar antenna segment 302 and said second diamond shaped planar antenna segment 304; and wherein said balun assembly includes a balun 400A having at least a first tubular ferrite segment 400G having a first ferrite lumen 400H therethrough and a second tubular ferrite segment 400I having a second ferrite lumen 400J therethrough; wherein said first tubular ferrite segment 400G aligned in parallel with and bound to second tubular ferrite segment 400I with three balun winding wire segments (e.g., 400K, 400L, 400M) wound through the first and second parallel ferrite segment lumens 400H, 400J;
and wherein said balun wire segment 400K is connectable to a first antenna connection 400E and extends up through first lumen 400H continuing down through lumen 400J and is connected to a center pin 400C of a coaxial connector 400B for connection to a radio while said second hand-wound balun wire segment 400L is connectable to second antenna connection 400F and extends up through second ferrite lumen 400J continuing down through first ferrite lumen 400H and is connected to a conductive shield 400D of a coaxial connector 400B and a third hand-wound balun wire segment 400M is connectable to coaxial connector center pin 400C and extends up through first ferrite lumen 400H continuing down through second ferrite lumen 400J and then loops back to up through first ferrite lumen 400H a second time continuing down through second ferrite lumen 400J a second time where it is then connected to the coaxial connector shield 400D of coaxial connector 400B.

18. A method for deploying and erecting a Multi-band (HF, UHF and VHF) vertical diamond antenna system (e.g., 100), comprising:
(a) providing a kit with easily carried cases containing disassembled antenna system components including a Base assembly 120, a Mast assembly 200 configured to be removably attachable to said base assembly, an Antenna assembly 300 configured to be connected to a Balun Matching Transformer assembly 400 and a plurality of radially projecting Radial elements 500;
(b) assembling and erecting said base 120 and attaching at least a lower portion of said mast 200;
(c) attaching the structural components and electrically conductive elements or components 310, 320, 330 and 340 of said antenna assembly 300 to said mast assembly and at least partially extending said mast assembly and configuring said antenna's structural and electrically conductive components to provide a diamond-shaped array when said mast is fully extended;
(d) connecting said balun matching transformer assembly 400 and radial elements 500 to said antenna assembly and to an HF, UHF or VHF radio or transceiver which can be employed to project and receive HF, UHF or VHF signals in a selected radiation pattern having a selected main beam shape and providing a selected gain over a selected frequency band.

19. The method of claim 17, wherein said step of attaching the structural components and electrically conductive elements or components 310, 320, 330 and 340 of said antenna assembly 300 to said mast assembly comprises attaching antenna wire elements to a top hub assembly and affixing said top hub assembly carrying connections to said elements or components 310, 320, 330 and 340 to or proximate a top end of said mast assembly.
